(19) United States
(12) Patent Application Publication
(10) Pub. No.: US 2022/0309491 A1
(43) Pub. Date: Sep. 29, 2022

(54) Non-Fungible Tokens and Uses Thereof

(71) Applicant: Glowforge Inc., Seattle, WA (US)

(72) Inventors: Daniel Shapiro, Mercer Island, WA (US); Mark Gosselin, Seattle, WA (US); Michael Natkin, Seattle, WA (US); Jonathan Daniel Park, Seattle, WA (US); Bonny P. Lau, Seattle, WA (US); Scott Haug, Seattle, WA (US); Nicodemus Empyream Paradiso, Seattle, WA (US); Jonathan P. Lang, Santa Barbara, CA (US)

(21) Appl. No.: 17/701,265

(22) Filed: Mar. 22, 2022

Related U.S. Application Data
(60) Provisional application No. 63/165,047, filed on Mar. 23, 2021.

(51) Int. Cl. G06Q 20/36

(52) U.S. Cl. CPC G06Q 20/3674; G06Q 2220/00

(57) ABSTRACT

Disclosed embodiments include rendering systems configured to: (i) after receiving a request from a user to render a creative work associated with a non-fungible token, determining (a) whether the user owns the non-fungible token and (b) a current render count corresponding to how many times the creative work associated with the non-fungible token has been previously rendered; and (ii) when the user owns the non-fungible token and the current render count indicates that the creative work has been previously rendered fewer than a maximum render count corresponding to a preconfigured total number of authorized renderings of the creative work associated with the non-fungible token, (a) obtaining an implementation file corresponding to the creative work, (b) rendering the creative work according to the implementation file, and (c) updating the current render count to reflect another rendering of the creative work.

### CROSS-REFERENCE TO RELATED APPLICATIONS

The present application claims priority to U.S. Provisional App. 63/165,047 titled “Non-Fungible Token and Uses Thereof,” filed on Mar. 23, 2021, and currently pending. The entire contents of App. 63/165,047 are incorporated herein by reference.

### BACKGROUND

Non-fungible tokens (NFTs) have emerged as items of exchange for use in, for example, virtual goods markets. NFTs are unique tokens exchanged on blockchains. While NFTs may have many applications, they are often associated with creative works. For example, an NFT may contain a link to a file storing a copy of its associated creative work. It may also contain other information, such as text.

Platforms for creating and trading NFTs currently exist. However, the exact nature of exclusivity that attaches to the ownership of an NFT or rights in a creative work associated with an NFT is often not what creators, sellers, and purchasers of NFTs expect. For example, an NFT may be associated with a creative work that is widely available for viewing by anyone, and not only by the holder of the NFT. An NFT transfer generally does not carry with it a transfer of any intellectual property rights of the associated creative work. A copyright on a creative work that is associated with an NFT may be retained by the creator of the creative work, while third parties may use images of the creative work to create NFTs without the knowledge or permission of the creator or other copyright holder.

What is needed is a system that allows for creation and rendering of NFTs, as well as blockchain operations that support this creation and rendering, while appropriate ownership, permissions, payments, and/or rights to the NFT and/or the associated creative work associated with an NFT are retained by or transferred to appropriate parties. These appropriate parties, permissions, and rights may be chosen to fit a variety of models, as explained herein.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

FIG. 1 is a diagram illustrating features of a non-fungible token (NFT) system consistent with some implementations of the current subject matter;

FIG. 2 is a flowchart of an example NFT process consistent with some implementations of the current subject matter;

FIG. 3 is a flowchart showing features of another example NFT process consistent with some implementations of the current subject matter;

FIG. 4 is a flowchart showing features of another example NFT process consistent with some implementations of the current subject matter;

FIG. 5 is a flowchart showing features of another example NFT process consistent with some implementations of the current subject matter;

FIG. 6 is a flowchart showing features of another example NFT process consistent with some implementations of the current subject matter;

FIG. 7 is a flowchart showing features of another example NFT process consistent with some implementations of the current subject matter;

FIG. 8 is a flowchart showing features of another example NFT process consistent with some implementations of the current subject matter;

FIG. 9 depicts an elevational view of an example of a computer numerically controlled machine consistent with some implementations of the current subject matter;

FIG. 10 depicts a top view of an example of a computer numerically controlled machine consistent with some implementations of the current subject matter;

FIG. 11A depicts a transparent side view of an example of a computer numerically controlled machine consistent with some implementations of the current subject matter;

FIG. 11B depicts a transparent top view of an example of a computer numerically controlled machine consistent with some implementations of the current subject matter;

FIG. 12 depicts a system diagram illustrating an example of a computer numerically controlled processing system consistent with some implementations of the current subject matter;

FIG. 13 depicts a block diagram illustrating a computing system consistent with some implementations of the current subject matter; and

FIG. 14 depicts aspects of a method implemented by a rendering system according to some embodiments consistent with some implementations of the current subject matter.

### DETAILED DESCRIPTION

Provided herein are systems and methods for creation and rendering (e.g., displaying on a screen, printing in a physical medium, etc.) of a creative work associated with a non-fungible token (NFT). The NFT may correspond to or otherwise carry with it indications of a variety of rights and permissions associated with the creative work as described herein. In some embodiments, systems and methods of the present invention enable creators to sell authenticated designs or other creative works to be rendered in physical form, possibly for limited reproduction. Some embodiments may enable a creator to securely sell a unique piece of physical artwork to a buyer without physically transporting the object. For example, a limited edition creative work may be created by an artist or other creator, and files embodying that creative work may be distributed via intermediaries and bought and resold digitally. When the creative work is reduced to physical form (i.e., referred to herein as “rendered”), the physical form of the creative work may finally be delivered to the ultimate owner. A platform may be used to create vouched NFTs, such that a file embodying the creative work is available to the owner of the NFT, the creator is certified as having created the NFT, and further, the file embodying the creative work may be encrypted.

These systems and methods may be used in both trusted (i.e., secure) and non-trusted (i.e., not secure) environments. For example, programs, entities, and/or companies may be designated as trusted, and software associated with a creation system may indicate the source of an NFT as one of a list of trusted programs, entities, and/or companies. Similarly, the software associated with a rendering system may indicate the rendering of a creative work associated with the NFT will be performed by a trusted program, entity, and/or company. In one example, the NFT itself may include or indicate a list of programs, entities, and/or companies that are trusted to carry out transactions related to a creative work associated with the NFT, and may be used to institute limitations on behavior based on whether parties appear on those lists.

In another example, the NFT may include a link or address that may contain a list of programs, entities, and/or companies that are trusted to carry out transactions on files associated with the NFT, and may be used to institute limitations on behavior based on whether parties appear on those lists. This may be included or indicated in the NFT, for example, using a smart contract associated with the NFT or other data included in the NFT, including but not limited to metadata associated with the NFT. The systems and methods described herein may also be incorporated into a trusted program in order to enable the creation of a creative work, mint or verify an NFT, add an NFT to a blockchain, encrypt a file embodying a creative work, or securely render a creative work, while the owner of the NFT maintains permissions and rights.

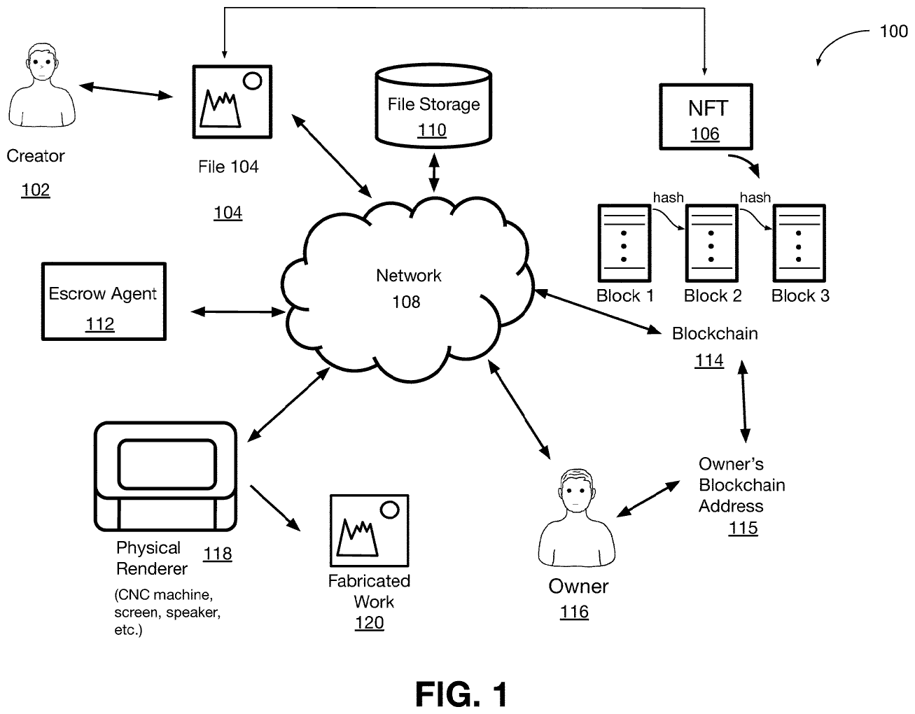

FIG. 1 depicts an example embodiment of an NFT system 100 as described herein, including examples. As shown in FIG. 1, an artist or creator 102 produces a file 104 embodying a creative work. The file 104 can be associated with an NFT 106, which may be minted on and reside on a blockchain 114. As required, components of the system 100 may communicate with each other via a network 108, which may be a local network, remote network, wireless network, a direct connection, or any suitable data transmission network. The NFT 106 can reference a file, which may be the original file 104. That file may be stored in a file storage medium 110, transferred to an escrow agent 112, and/or transferred according to the instructions of the owner 116 of a blockchain address 115. In some embodiments, the file referred to by the NFT may be sent to a physical rendering machine 118. In some embodiments, a reference to the NFT may be sent to a physical rendering machine 118, and/or the physical rendering machine 118 (or a computer associated with it) may evaluate the blockchain to confirm NFT ownership, and the physical rendering machine 118 (or a computer associated with it) may retrieve the file 104 itself. Once the NFT 106 is transferred to the owner 116 (or the blockchain is updated to reflect that owner 116 owns the NFT), the owner 116 may choose to transmit the file 104 associated with the NFT 106 to any of the previously described entities or media via the network 108, or to send the file 104 to a physical rendering machine 118 to create a fabricated work 120, i.e., send the file 104 to the physical rendering machine 118, which in turn renders the creative work, thereby generating the rendered creative work. In such embodiments where the physical rendering machine 118 uses the file 104 to render the creative work, the file 104 is sometimes referred to herein as an implementation file.

In some embodiments of the present invention, participants on either the blockchain 114 or the network 108 may verify NFT ownership as required for certain operations to be authorized and/or to proceed. People, entities (such as businesses), and machines interacting with the system 100 may be provided with blockchain addresses to facilitate the transfer of ownership of the NFTs, where required. It is to be understood that individual creators or owners as described herein may be replaced with collectives, businesses, or decentralized autonomous organizations (DAOs) in some embodiments. Additional examples and embodiments of the use, sale, and protection of the NFT 106 are described herein.

### Definitions

A “non-fungible token” or “NFT,” as used herein, is generally understood to refer to a unit of data in token form on a digital ledger such as a blockchain. Each NFT may have unique properties that distinguish it from other NFTs, and each NFT can be associated with and represent a unique digital item, and thus in general NFTs are not interchangeable with one another. NFTs can represent and contain links to digital files such as art, audio, video, and other forms of creative work. While the digital files themselves may be reproducible, ownership of the NFTs associated with the digital files are tracked on their associated blockchains and provide holders/owners of the NFTs with proof of ownership of the NFTs. NFTs according to some embodiments include one or more links to one or more implementation files, where the implementation file(s), when executed by a physical rendering machine, cause the physical rendering machine to render the creative work associated with the NFT.

A “blockchain” as used herein, is generally understood to refer to a growing list of records called blocks, which are linked using cryptography. Each block contains a cryptographic hash of the previous block, a timestamp, and transaction data. By design, a blockchain is resistant to modification of its data. Once recorded, in a typical blockchain the data in any given block cannot be altered retroactively and accepted by participants in the network without alteration of all subsequent blocks.

A “creative work” as used herein is generally understood to refer to a creative expression or application of creative and/or industrial skill and imagination, such as a design, illustration, photograph, sculpture, painting, composition, text, software code, binary executable, song, signal, set of instructions to render a creative work, sketches, models, decorative items, craftworks, films, audio-visual work, videos, video games, jewelry, or other creative work or similar manifestation of creative and/or industrial effort. Creative works include works that are traditionally protectable by copyright laws and works that may not be protectable by copyright laws

The term “vouched” as used herein is generally understood to refer to the fact that an entity vouches or certifies that a creator, e.g. the creator of an NFT, has a specified identity. Vouched status does not necessarily indicate encryption status.

As used herein, the term “laser” includes any electromagnetic energy or focused or coherent energy source that (in the context of being a cutting tool) uses photons to modify a substrate or cause some change or alteration upon a material impacted by the photons. Lasers (whether cutting tools or diagnostic) can be of any desired wavelength, including for example, microwave, lasers, infrared lasers, visible lasers, UV lasers, X-ray lasers, gamma-ray lasers, or the like.

It will be understood from the current disclosure that various types of computer numerically controlled (CNC) machines may be used in association with one or more of the features described herein. For example, a CNC machine may be a machine that is used to perform additive processing and/or subtractive processing under the control of a computer (which may be the controller for the CNC machine itself in some implementations). The computer numerically controlled machine may include one or more motors (or other actuators) that move one or more heads performing the addition and/or removal of material. For a CNC machine that performs additive processing by depositing a material, the one or more heads may incorporate nozzles that spray or release polymers. Alternatively and/or additionally, the heads can include an ink source such as a cartridge or pen. In the case of 3D printing, material can be built up layer by layer to create a 3-dimensional object. A CNC machine that performs subtractive processing by removing material can include, without limitation, one or more of a laser or other source of focused or unfocused electromagnetic energy or heat, a cutting blade or blades (e.g., that rotate, oscillate, or the like), a grinding device, etc. The example of a laser CNC machine is used in the following description for the purposes of informative illustration. It will be understood that many of the processes described can also be readily applied to a CNC machine that performs additive processing.

In a laser CNC machine, the electromagnetic energy delivered to the material may effect one or more changes in the material. For example, the one or more changes in the material may include a removal of one or more portions of the material, which may be achieved by one or more cuts that partially and/or fully penetrates the material. In some example embodiments, the one or more changes may correspond to a creative work formed by combining or otherwise modifying a relationship between two or more objects. For instance, the one or more changes may correspond to a creative work formed by applying, to multiple objects, one or more Boolean operations such as union, subtraction, intersection, removal of the overlapping areas of two or more of the objects, and/or the like. In another instance, the one or more changes may correspond to a creative work formed by aligning multiple objects such as, for example, align left, align horizontal centers, align right, align top, align vertical centers, align bottom, and align centers. In yet another instance, the one or more changes may correspond to a creative work formed by spacing multiple objects such as, for example, with equal space between object edges or perimeters, equal space between object centers, etc. Alternatively and/or additionally, the one or more changes may correspond to a 3-dimensional treatment applied to one or more edges along a perimeter of the material or along an edge or transition between two parts of the material with differing heights or depths. Examples of edge treatments may include a chamfer (e.g., a sloped or angled edge) and a fillet (e.g., a rounded or smooth edge), which may be achieved by delivering electromagnetic energy to create a variable depth engraving along at least a portion of the perimeter of the material.

As used herein, the terms “render” or “rendering” are generally understood to refer to the action of creating any type of physical or tangible embodiment of a creative work via any type of rendering machine. For example, creating a physical or tangible embodiment of a creative work includes, but is not limited to, (i) for some visual creative works (e.g., pictures, drawings, artistic scripts, etc.), displaying an image, video or other visual representation of the creative work on a screen, display device, and/or printing the visual creative work onto a tangible material such as paper, wood, plastic, metal, or other suitable material now known or later developed via a printer, a three-dimensional (3D) printer, a computer numerically controlled (CNC) machine, a laser cutter, or other suitable manufacturing device, (ii) for some audible creative works (e.g., songs, music, etc.), emitting an auditory sound or signal or series of sounds and/or signals corresponding to the creative work via one or more speakers or other suitable audio output devices now known or later developed, (iii) for some audio-visual creative works (e.g., movies, films, animations, etc.), displaying an audio-visual representation of the creative work via one or more screens, projectors, displays, or other suitable audio-visual output devices now known or later developed, (iv) for some structural and/or sculptural creative works (e.g., models, figurines, crafts, jewelry, etc.) creating, recreating, or otherwise manufacturing, fabricating, or producing a physical embodiment of one or more objects associated with the creative work via a three-dimensional (3D) printer, a computer numerically controlled (CNC) machine, a laser cutter, or other suitable manufacturing device, and/or (iv) for some written creative works, printing a document corresponding to the creative work via a printer, display screen, or other suitable output/display device now known or later developed.

As used herein, a “rendering machine” may include, for example, a printer, a three-dimensional (3D) printer, a computer numerically controlled (CNC) machine, a laser cutter, a display screen, an audio device, a personal computing device, a fabricator, or other similar device capable of rendering an image, object, signal(s), or any other physical or tangible embodiment or manifestation of a creative work as previously described.

As used herein, the term “printing” can generally refer to altering the appearance, properties, and/or state of a material. Printing can include, for example, making a through-cut, engraving, bleaching, curing, burning, etc. Engraving, when specifically referred to herein, indicates a process by which a computer numerically controlled machine modifies the appearance of the material without fully penetrating it. For example, in the context of a laser cutter, it can mean removing some of the material from the surface, or discoloring the material e.g., through an application of focused electromagnetic energy delivering electromagnetic energy.

Also, as used herein, unless otherwise specified, the term “material” includes the material that is on the bed of a computer numerically controlled machine or rendering machine. For example, if the computer numerically controlled machine is a laser cutter, lathe, or milling machine, the material may be the raw material, stock, and/or the like that is placed in the computer numerically controlled machine for cutting. In another example, if the computer numerically controlled machine is a 3-D printer, in which case the term “material” may refer to either the current layer, or previously existent layers or substrate, of an object being crafted by the 3-D printing process. In yet another example, if the computer numerically controlled machine is a printer, the material may be the paper onto which the computer numerically controlled machine deposits ink. The term workpiece is also used in certain examples to refer to material having or being in progress toward a creative work resulting from one or more additive and/or subtractive processes of the CNC machine as determined by user input, for example via the user interface.

Also, as used herein, “cameras” includes, for example, visible light cameras, black and white cameras, IR or UV sensitive cameras, individual brightness sensors such as photodiodes, sensitive photon detectors such as a photomultiplier tube or avalanche photodiodes, detectors of infrared energy far from the visible spectrum such as microwaves, X-rays, or gamma rays, optically filtered detectors, spectrometers, and other detectors that can include sources providing electromagnetic energy for illumination to assist with acquisition, for example, flashes, UV lighting, etc.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

In some embodiments, a creative work may be created in the form of a digital file that contains something creative, such as a painting, an image, scalable vector graphics (SVG) that can be printed on a printer or rendering machine, an audio recording, a video, a text document, software code, binary executable, or any other form of instructions that may be expected to ensure rendering and/or replication (if permitted) of the creative work.

In some embodiments, data can be provided to indicate how a creative work was created. This indication may not be completely conclusive, but it can help to indicate how the creative work was created and/or by whom it was created. For example, the data provided may be in the form of a video of someone composing a song, a screen recording of someone drawing a creative work from scratch, a photo of someone taking a photo, or the like. In some embodiments, the indication of creation may be a camera “selfie” photograph, showing the creator after printing, creating, or scanning, etc. an object or other creative work via a rendering machine. The photograph may potentially be taken using the rendering machine's own camera (e.g., a lid camera on a CNC machine) and carry with it data showing the identity of the rendering machine taking the photograph and the time and/or date of the photograph. In another example, the data indicating creation may be an identifier of the source used to generate the creative work and the elements used to create the creative work. For example, data indicating creation may comprise a digital trail (e.g., a string of timestamped data) that describes how the creative work was created, such as a serial number of the machine used, user identification data (e.g., user ID of a user of a software or a machine used to create the creative work), or the like. Some additional examples are provided below (these examples are not meant to be exhaustive, and can be combined).

For creative works created within or using a software program, the creation indication data may include a software version, dates the creative work was started, worked on, and/or completed, a user ID, native design elements from the software program, or other similar data.

For creative works created within or using a software program that also includes a scanned image from the machine running the software program, the creation data may include a software version, a date the creative work was started and/or completed, a user ID, native design elements from the software program, a hardware serial number of the machine used to create the creative work, a photo of an original object or creative work scanned from a machine, a photograph such as a lid camera selfie as previously described, or other similar data.

For creative works created within a software program that also includes files (e.g., images) that were added as part of the creation, creation data may include a software version, dates the creative work was started, worked on, and/or completed, a user ID, native design elements from the software program, data identifying a file added (e.g., a file that was uploaded on a specified date, having a specified size and/or a specified hash value), or other similar data.

In some embodiments, creation data may include a series of data, for example combined into a video, demonstrating a user or creator taking creative actions to create the creative work. For example, such data indicating creation may comprise a screen recording, or a reconstruction of some or all of the user or creator's screen based on recorded mouse clicks and/or keyboard strokes, or the like. This might, for example, allow someone to reconstruct some or all of the creative process that was used to arrive at the final file.

In some embodiments, a vouched indication of creation may be provided. This vouched indication of creation may involve a trusted third party that vouches for the veracity of the indication of creation. It may involve the trusted third party vouching that the indication of creation represents what it is described to represent, that it was created in accordance with some implied or defined standard (for example that the video was recorded automatically and not edited), that it was created by the same user account that initiated creation of the NFT, or various other guarantees.

In some embodiments, creation software may be used that captures and records a digital trail memorializing or describing how the creative work was created. For example, data indicating each keystroke, each imported image, each scanned image, and the resulting creative work (such as, for example, an image) can be captured by the creation software, thereby producing an indication of creation. The creation software may securely indicate (e.g., through a digital signature, verified user ID, etc.) additional verification information about the creation, for example that the creation was created by a logged-in user having a specified identity. The creation software may also include data such as the name of the user, user's address or location, status of a verified credit card or other identification of the user held on file, data relating to identity documents provided by the user concurrently or previously when creating or updating their creation software account, or other similar verification data.

In some embodiments, the creation software may take action to verify or mint (or cause to minted) an NFT that contains or provably references the indication of creation. For example, in some embodiments, the creation software may interact with a smart contract on a blockchain to cause the smart contract to mint (i.e., generate) an NFT that is associated with the creative work and perhaps one or more files associated with the above described indication of creation. In operation, the association between the NFT and the creative work and the indication of creation files in some embodiments is via one or more links to off-blockchain memory locations storing (i) one or more files that embody the creative work and (ii) one or more files that embody the indication of creation.

Alternatively, the creation software may package the indication of creation into a creation indication package, such as a file, that may be referenced in an NFT that is minted separately. For example, an NFT may be created with a hash of the creation indication package, so that future hashing of the creation indication package can demonstrate that the hash contained in the NFT shows a clear record of that package having been created at (or before) the time of minting. If the creation software communicates securely with the software that is used to mint an NFT, the software may also request that the user re-enter their password when minting the NFT to ensure the user identity hasn't changed, and/or may take a photo of the user when minting the NFT, for example to be able to later verify that it matches the image of the person present in the prior recorded indication of creation. In another example, the creation software may store the creation indication package, maintain a reference to the NFT for the creation indication package, and advertise the existence of the creation indication package with reference to the NFT. In some embodiments, the creative work may be created using an identified piece of software which carries its own verification data such as serial number, version number, or the like. Additionally and/or alternatively, a web browser used in creation of the creative work may be identified, or a software may store the serial number, version number, or other identifiers of the application used to create the creative work. In another example, the creative work may be created using an identified device and/or location, and data such as the Internet Protocol (IP) or media access control address (MAC address) of the device may be used to verify that the creative work was created from a single IP address or estimated global position system (GPS) location. In another example, the indication of creation might include the provision of certain cryptographic keys, proving the ownership of certain entities on the blockchain, provision of an image of identification, a testament from a third party in some form, or other indicators of identity.

In one example, a verification step may be used to screen content (e.g. using reverse-image web search, etc.) that is imported or added to a creative work to see if the content already exists prior to verification. In another example, the entire creative work may be screened to see if the creative work includes content that already exists prior to verification. The results of the verification (and verification method or verification tool used) may be captured and stored as part of the vouched indication of creation.

In general, the more information that can be verified, the easier it will be for downstream participants, such as experts or verification programs or systems, to verify provenance of a creative work. Furthermore, the level of detail or information that is captured and stored may be included at the creator's discretion. For example, in some cases increasing the assurance of provenance may enhance the value of a creative work and/or its associated NFT.

In some implementations, the indication of creation may be included in the NFT (either directly or with a link to the location of a file comprising the indication of creation) and/or maintained by a vouching party such that it is not publicly available or otherwise discernible without a party possessing some added permissions or performing decryption of at least some part of the information stored by the NFT. For example, there may be situations where a creator prefers the indication of creation to not be freely available to all.

In some implementations, the NFT may indicate a trusted party (which may include a trusted software agent) who can provide the indications of creation, depending on their reputation to provide assurances. For example, it may indicate that physical proof or signed contracts are viewable by contacting a certain party, or that inquiries may be directed to certain parties.

A vouched NFT is an NFT that includes or refers to a vouched indication of creation. For example, a vouched NFT might include a link that points to a digital image drawn in a certain photo-editing software; points to a screen recording that shows the image being drawn, hosted by the author of the photo-editing software, who attests that the video was made using their software by a certain user on a certain date; and/or points to a one-way cryptographic hash of identification information (such as, for example, the social security number and photo-editing software password) of the creator. The creator can easily replicate the cryptographic hash to indicate that they possess the identification information to verify that they created the work referred to in the NFT.

In some embodiments of the present invention, NFTs may contain or refer to certificates of authenticity (CoA). An NFT associated with a CoA may have an open scalable vector graphics (SVG) file or other digital instructions that allow rendering a CoA, and may be utilized to print a certificate of authenticity that accompanies the NFT and/or the creative work associated with the NFT. For example, a creator may mint a cleartext SVG (i.e., a message or data which is in a form that is readable by a human being without additional processing) into an NFT representing or otherwise associated with a creative work.

In some examples, the NFT may be associated with a CoA that can be rendered only by the owner of the NFT. While anyone may be able to print, render, or view the creative work, only the owner of the NFT would be able to print, render, or view the CoA.

A creative work may have a limited number of serial numbers, where the first time the creative work is printed it has serial number 001, the second time it has serial number 002, etc. The secondary market for lower serial numbers may be stronger than that for higher serial numbers (i.e., it is more valuable to own a copy with serial number 001 than a copy with serial number 100). An identifier of the serial number may be included in the CoA and updated at time of print, creating a situation where users “race” to render embodiments of the creative work earlier to get a lower serial number. In some embodiments, no action may be taken to prevent anyone in the world from rendering an embodiment of a creative work, while owning the NFT gives a user the right to print a certificate of authenticity.

In some embodiments, if the creative work is changed prior to printing (or any other physical rendering), the certificate of authenticity may not be printed (or rendered in physical form) if the creative work has changed substantially from the original form. A record of action for the certificate of authenticity may also be updated once physical rendering is complete. For example, a smart contract may be used or a page (such as a secure page) that is linked to by or referenced in the NFT may be updated to indicate an action has occurred. Examples of uses of certificates of authenticity in some embodiments of the present invention include (but are not limited to): printing a certificate of authenticity which may include unique information from its associated NFT, a serial number of the creative work, and the owner's identification (e.g. a digital wallet ID, user ID, public key, or other suitable identification); embedding a certificate of authenticity into a creative work (for example, the certificate of authenticity could be a code that can be embedded into the creative work and/or into a file embodying the creative work and scanned to provide the certificate of authenticity); tying a certificate of authenticity to a unique feature, pattern, or data string of the material on which the creative work is printed (this can be done, for example, by scanning the material for a unique identifier (e.g., code printed on Proofgrade™ material such as that available from Glowforge Inc. of Seattle Wash., unique code invisible to the eye (e.g., UV code) may be printed on the wood, unique grains in wood, etc.) and storing information related to the unique feature, pattern, or data string once the print is complete).

A certificate of authenticity may be scanned to review the ownership history of the NFT and confirm that the person claiming ownership is the current owner of the NFT. For example, a personal computing device such as a smartphone may be used to scan a certificate and display an image or overlay that shows the identity of the current owner of the NFT. Additionally and/or alternatively, a print or creation may be verified wherein the owner, after printing a particular certificate of authenticity, can further annotate the provenance of their certificate of authenticity by posting pictures of the object or other creative work along with its certificate of authenticity. In some embodiments, the posting process would recognize both the certificate of authenticity and the creation at time of posting the image. In other embodiments, the certificate may be added to a “preview” referred to by an associated NFT, as a digital record that this creative work has been printed. In one embodiment, when an NFT is later sold or otherwise transferred, the certificate of authenticity may no longer be valid, and the new owner of the NFT can print a new certificate of authenticity tied to the new owner. Thus, in some embodiments, anyone can recreate a creative work, but only the owner of an NFT would own a certificate of authenticity connected the work.

Support elements enabling the use of an NFT for a certificate of authenticity may include: a method of minting; a smart contract; a simple design generator that produces the certificate of authenticity ready to print and/or render in physical form; a barcode and/or other identifier which can be scanned and/or read by a camera or barcode reader and used to generate or obtain a link that points to the NFT ownership history; or different designs for the certificates or displays for the certificates.

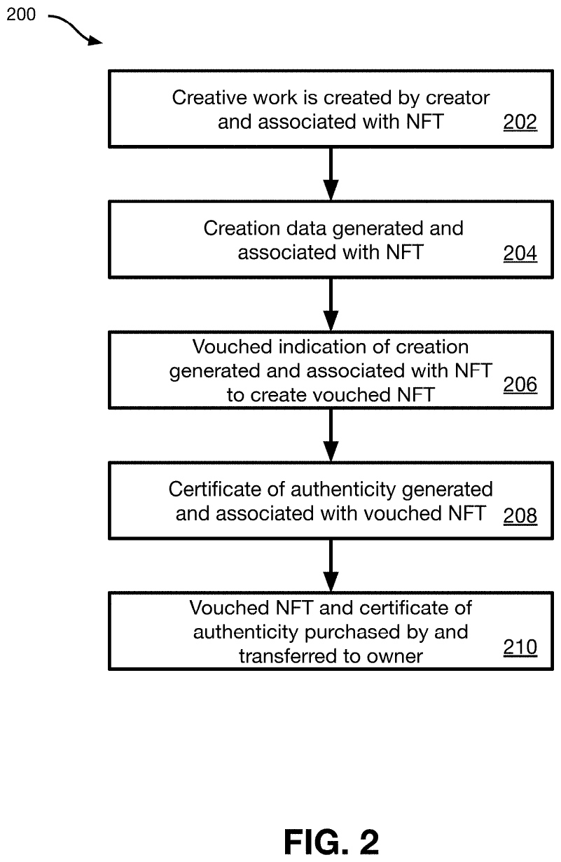

FIG. 2 is a flowchart illustrating aspects of a process in some embodiments of the present invention. In the NFT process 200 shown in FIG. 2, at 202 a creative work is created by an artist or creator and associated with an NFT. In some embodiments, the artist or creator uploads or otherwise provides the creative work to a rendering system, and the rendering system facilitates creation of an NFT associated with the creative work as described herein.

At 204, creation data corresponding to the creation of the creative work is generated (e.g., generated by software tools used to create the creative work) and associated with the NFT. In some embodiments, associating the creation data with the NFT associated with the creative work includes the rendering system causing or otherwise facilitating metadata of the NFT to include a link or other pointer to a memory location (on or off the blockchain) where the creation data is stored so that anyone interested in purchasing the NFT can access and/or review the creation data.

At 206, a vouched indication of creation is generated and associated with the NFT to create a vouched NFT. In some embodiments, the rendering system, individually or in combination with other software systems, causes or facilitates the generation of the indication of creation. For example, and as described further herein, software used to make the creative work may generate timestamps or similar creation data that tracks, e.g., how long the creator worked within the software on the file(s) that embody the creative work and/or when the creator completed the file(s) that embody the creative work. Similarly, the creator can capture timestamped images of the creative work during the creation process and/or images of the final, completed creative work. In some embodiments, a third party may review the creation data to confirm that the creation data appears authentic and/or accurately represents or documents the creation of the creative work, and then provide the rendering system (and/or perhaps software program associated with the rendering system) with an indication that the third party has vouched for the authenticity or accuracy of the creation data. In some embodiments, associating the timestamped creation data (e.g., from the creation software, images of the creation process/completion, and perhaps other creation data) vouched by the third party with the NFT (e.g., via links to the creation data in the NFT metadata), results in the “vouched NFT.”

At 208, a certificate of authenticity is generated and associated with the vouched NFT. In these steps, association with the vouched NFT may comprise including within the vouched NFT information (such as a link, hash, text, and/or code) confirming the association between the certificate of authenticity and the vouched NFT. Finally, at 210, the vouched NFT and certificate of authenticity are purchased and/or transferred to the owner, who may optionally produce a physical representation of the CoA as discussed above.

In some embodiments, an NFT is provided wherein a vouching party additionally attests that the artist or creator of the creative work associated with the NFT has, in a legally binding manner that the vouching party has verified, transferred certain rights of ownership (e.g. the full copyright of the creative work, or the exclusive or nonexclusive right to make a specified quantity of physical prints) to the owner of the NFT. This functionality may be incorporated into several different embodiments of the present invention. For example, a contract associated with the sale of the NFT may include clauses and conditions that specify the particular rights that are transferred from each NFT seller to each NFT purchaser each time ownership of the NFT is transferred. In one example, a condition of subsequent transfer may require an NFT seller to sign (e.g., electronically sign or via “click-through agreement”) a standard contract that transfers all the NFT seller's rights in the NFT (and the associated creative work) to the NFT purchaser. By making each subsequent sale of the NFT require agreement to such a contract (which can be included within or linked to in the NFT metadata), the NFT creator can ensure that each subsequent owner can enjoy the same rights assigned via the contract.

In some embodiments, a smart contract may specify a public key that proves ownership of the good or creative work. For example, hardware security modules (HSMs) with pre-programmed key pairs as physical tags may be used. When a purchaser wants to couple digital ownership of an NFT with ownership of a physical piece embodying a creative work, the purchaser may scan the physical tag to obtain its public key and that key may then be encoded in the blockchain that the NFT resides on, e.g., by updating the NFT metadata to include the public key of the physical tag. Only one of each tag may exist, and the private keys are very difficult to extract without sophisticated attacks. The tags would be similar in nature to multi-factor authentication (MFA) tokens. In some embodiments, the tag may also have the certificate of authenticity included.

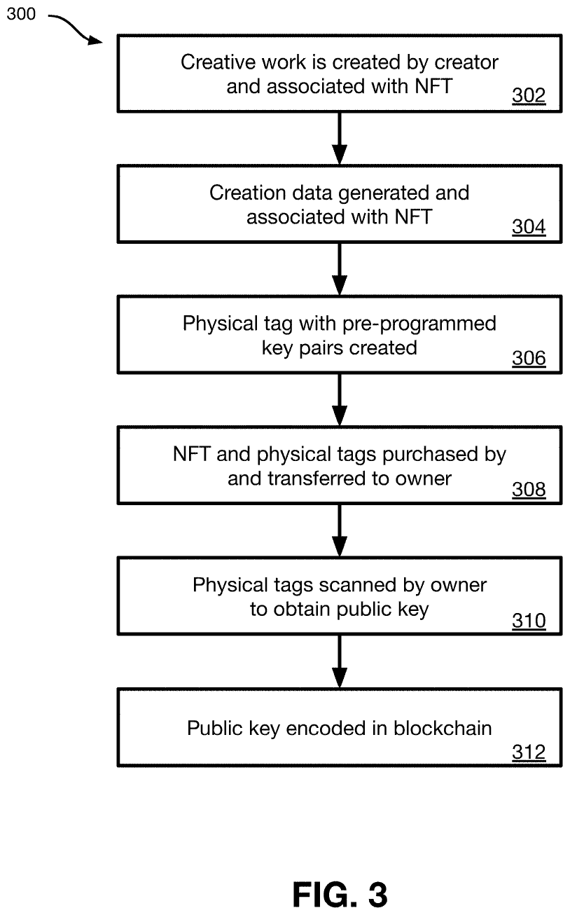

FIG. 3 is a flowchart illustrating some aspects of embodiments of the above processes. In the NFT process 300 shown in FIG. 3, at 302 a creative work is created by an artist or creator and associated with an NFT via any of the methods for associating an NFT with a creative work described herein. At 304, creation data is generated and associated with the NFT via any of the methods for associating creation data with an NFT described herein. At 306, a physical tag with pre-programmed key pairs is created or obtained. At 308, the NFT and physical tags are purchased by and transferred to the owner. At 310, the physical tags are scanned by the owner to obtain the public key. Finally, at 312, the public key is encoded in a blockchain (for example by the creation of a new NFT or association with an existing NFT).

In some embodiments, a protected NFT may be created that refers to a creative work such that renderings embodying the full quality of the creative work are available only to the owner of the NFT. For example, a file embodying the creative work may be digitally encrypted, using a key held by a third party. The third party may be required to verify ownership of the NFT before decrypting the file, and then the third party may deliver the decrypted file contents only to the verified owner. In another example, the third party may not encrypt the work, but only hold it in a secure manner, released only to the person proving they own the NFT.

In some embodiments, an encrypted file embodying the creative work may be encoded with a public key held by the NFT owner, for example the public key in a wallet held by the owner of the NFT. When the NFT is transferred, the NFT owner may decrypt the file embodying the creative work either manually or automatically via his or her private key, and then the file embodying the creative work may be re-encoded with a new public key held by the new NFT owner. In some embodiments, a homomorphic encryption scheme can re-encrypt the file embodying the creative work without decrypting it. In another example, the creative work may be decoded by the previous owner or by a trusted third party before being re-encoded with the new owner's key. Thus, anyone can verify the existence of the encrypted file embodying the creative work, but only the current owner can decrypt it. This solves problems that may arise when an NFT is owned by one person or entity, but anyone can enjoy the work by, for example, seeing a render of the work or rendering the work themselves. In one embodiment, the privilege of rendering and/or viewing a render of the work may be limited to the owner of the NFT associated with the work, for example, by requiring the file embodying the creative work to be decrypted with the NFT owner's private key before rendering. However, it may be possible that the first owner could decrypt the file embodying the creative work, copy the decrypted file, and then sell the NFT while retaining the ability to enjoy the creative work and distribute the file embodying the creative work. This problem can be solved with the following chain of custody NFT.

In some embodiments, a chain of custody NFT may be used. A chain of custody NFT is a protected NFT where the decrypted file embodying the creative work is only held by parties that commit to never copying the file in a manner that does not conform to an agreement tied to the minting of the original NFT’. For example, the combination of the NFT and its referred-to file (e.g., an implementation file or other file related to the creative work associated with the NFT) may be designed to mimic a precious document in a sealed envelope such that it is obvious whether the file the NFT refers to has been previously decrypted.

In one example implementation, a trusted company or piece of code (i.e. an “escrow agent” which can be automated or manual) is given the decryption key for a file embodying a creative work when an NFT associated with the creative work is originally minted. The NFT can be sold and resold, and at any time the owner can request the decryption of the file embodying the creative work, for example, to print or render a physical embodiment of the creative work associated with the NFT. The owner can do so by transferring ownership of the NFT to the escrow agent, who then (i) decrypts the payload (e.g., the file embodying the creative work, a pointer to the file embodying the creative work, an implementation file for rendering the creative work, or a pointer to an implementation file for rendering the creative work), (ii) logs an indication that the decryption occurred (e.g., minting or storing a new token, running a smart contract, updating a file stored by the escrow agent, etc.), (iii) ensures the NFT can no longer be used to access the creative work and/or the implementation file associated therewith (e.g., destroying the decryption key, removing the creative work from the previously accessible location, deleting an implementation file for rendering the creative work, etc.), and (iv) transfers ownership of the NFT and the decrypted file back to the owner. Now, the owner possesses the decrypted payload (e.g., the file embodying the creative work or pointer thereto, or the implementation file for rendering the creative work or pointer thereto) and is the first one who can enjoy the creative work (e.g., by rendering the creative work), but the NFT is like an empty envelope or ticket stub in that it no longer allows access to any file embodying the creative work or implementation file for rendering the creative work.

In yet another example, once a file for a creative work referred to by an NFT has been decrypted, access to the decrypted creative work may be removed from future NFT owners altogether, such as by deletion or destruction of the decryption key, removing the creative work from the previously accessible location, etc. In yet another example, once the creative work has been decrypted, the file for the creative work linked to by the NFT remains in existence, but is identifiable as no longer exclusive such that it may be sold a second time, but the new owner would know that prior copies now exist. In one simple example, the file for the creative work linked to the NFT may remain decrypted for all to access. In yet another example, once the creative work has been decrypted, the NFT may be “burned” by sending it to an unretrievable address.

Situations may exist wherein the original creator may have a copy of a file embodying their creative work, and could distribute the original file while maintaining the copy. To address provenance problems tied to this situation, the chain of custody can be extended to include the software or creative tool used in the creation of the creative work. For example, a creator may create the file using a software or creative tool. Because the software or creative tool is a part of the chain of custody, it records any instance of the creator saving a non-encrypted copy, and if such an instance is recorded, the software or creative tool does not allow for the creation of a vouched NFT from the file. If the creator commits to not creating a personal copy of the file, then when the creative work is complete, a vouched NFT is created with a link to the encrypted file and a link to a contract consistent with the creator's actions and intentions. If the creator has never accessed the decrypted file, then a vouched, chain of custody NFT can be created that ensures buyers that not even the creator can access the file embodying the creative work, thereby enforcing whatever scarcity is promised in a contract associated with the NFT transfer. Once the software or creative tool has minted (and/or interacted with a blockchain smart contract to cause the minting of) a vouched NFT guaranteeing uniqueness, it could then prohibit the minting of further NFTs using the file, since doing so would break the agreed upon rules of the trusted source who vouched for the NFT and violate its responsibilities in the chain of custody.

In some embodiments, ownership of an NFT may allow an owner the option to decrypt the original file embodying a creative work (e.g., an implementation file for rendering the creative work) and download it for themselves, or decrypt the original file embodying a creative work and make it public to all. In either case, that choice would be made public in the NFT itself (for example, a different type of NFT could be minted depending on the choice of the owner or intended owner), and could affect the trading value of the NFT. For example, an owner of the NFT may receive one copy of a file embodying a creative work (e.g., an implementation file for rendering the creative work), but have the option to release such a file freely (and may even sell and profit from sales of the file, albeit possibly after a pre-defined mandatory waiting period).

This total decrypt option (i.e., decrypting the file embodying the creative work and making it public to all) may also serve as a “nuclear option” to unlock the data of the file embodying a creative work while ensuring that future owners of the NFT can determine that this has occurred, such as in a case where the escrow agent who could unlock it has gone bankrupt, has ceased operations, or is otherwise unavailable to unlock the file embodying the creative work. Additionally and/or alternatively, the total decrypt option may be deployed automatically by the NFT or via a smart contract associated with the NFT. For example, a “dead man's switch” functionality may implemented via one or more smart contracts wherein, if one or more smart contracts associated with verifying ownership of the NFT and/or facilitating decryption of the file (e.g., implementation file) associated with the creative work by the escrow agent determines that the escrow agent's website (or other interface) has been unresponsive over a period of time, the one more smart contracts might automatically decrypt or otherwise facilitate or cause the decryption of the file embodying a creative work.

In one example, one or more smart contracts, software agents, or other suitable software programs may be configured to perform several functions, including (i) authenticating that an individual owns an NFT, and (ii) after authenticating that the user owns the NFT, instructing an escrow agent to decrypt the file(s) associated with the NFT (or enabling the escrow agent to decrypt the file associated with the NFT, e.g., by making appropriate keys available) and provide the decrypted file(s) to the authenticated NFT owner. In some embodiments, the escrow agent may store the file(s) associated with the NFT in a secure manner, but not necessarily in an encrypted form. In such embodiments, rather than instructing the escrow agent to decrypt the file associated with the NFT and provide the decrypted file to the authenticated NFT owner, the one or more smart contracts, software agents, or other suitable software programs may be configured to instruct the escrow agent to provide the file(s) associated with the NFT to the authenticated NFT owner without having to perform any decryption of the file(s) associated with the NFT prior to providing the file(s) associated with the NFT to the NFT owner.

In scenarios where the escrow agent stores the file(s) associated with the NFT in an encrypted form, if the one or more smart contracts, software agents, or other suitable software programs fail to receive an appropriate confirmation from the escrow agent (which may also be implemented via one or more smart contracts, software agents, or other suitable software programs) that the file associated with the NFT has been successfully decrypted and provided to the authenticated NFT owner, the one or more smart contracts, software agents, or other suitable software programs can facilitate or otherwise cause the file associated with the NFT to be decrypted, thereby preventing the file from otherwise being inaccessible because of the escrow agent's unavailability to decrypt the file. In some embodiments, the above-described “dead man's switch” functionality may be implemented automatically. In other embodiments, the above-described “dead man's switch” functionality may be implemented unless and until the NFT owner agrees to implementation of the “dead man's switch” functionality.

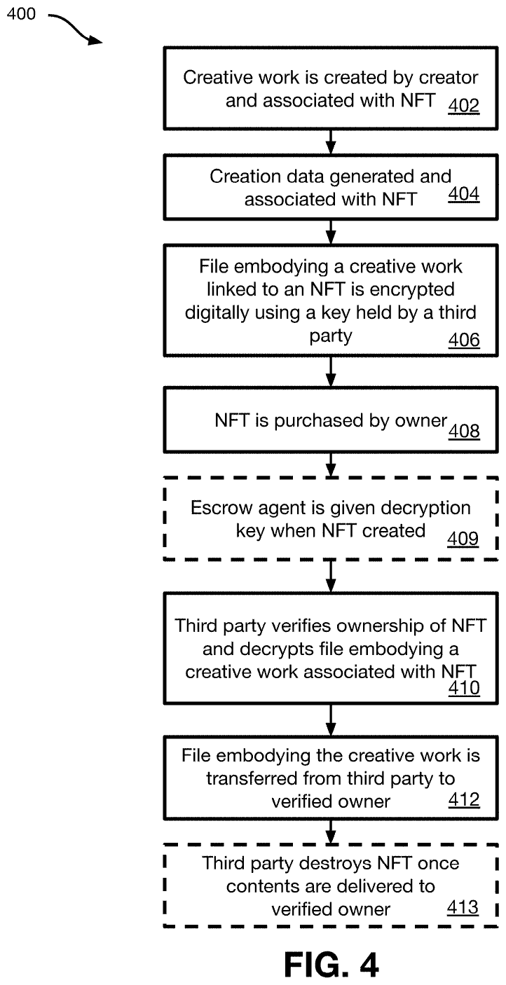

FIG. 4 is a flowchart illustrating aspects of some embodiments of the above processes. In the NFT process 400 shown in FIG. 4, at 402 a creative work is created by an artist or creator 102, as previously described and illustrated in FIG. 1, and associated with an NFT 106. At 404, creation data is generated and associated with the NFT 106 as described previously. At 406, the file embodying the creative work linked to the NFT 106 is digitally encrypted using a key held by a third party. At 408, when the NFT 106 is purchased, ownership of the NFT is transferred to the purchaser, who then becomes the current NFT owner. Optionally, at 409, an escrow agent 112, as previously described and shown in FIG. 1, is given a decryption key when the NFT 106 is created. The escrow agent may be an entity or device and may be automated or manual.

When the current NFT owner later sells the NFT to a purchaser and needs to transfer ownership of the NFT to the purchaser, the third party verifies that the NFT seller is the current NFT owner and decrypts the file(s) embodying the creative work using the key held by the third party. For example, at 410, the third party verifies ownership of the NFT and decrypts the file embodying the creative work associated with the NFT. In some embodiments, the third party verifying ownership of the NFT includes the third party verifying that the NFT seller is the current NFT owner via any of the verification methods described herein (e.g., via a digital signature or other suitable mechanism). And once the third party has verified that the NFT seller is the current NFT owner, the third party decrypts the file(s) embodying a creative work associated with the NFT 106. Then, at 412, the file embodying the creative work 106 can then be transferred from the third party to the to the NFT purchaser (i.e., the new NFT owner) pursuant to the NFT sale.

In some embodiments, rather than transferring the file(s) embodying the creative work to the new NFT owner, the third party may instead transfer (or otherwise make available) the file(s) embodying the creative work to a software agent associated with the new NFT owner, e.g., a printing escrow agent implemented by or in communication with the rendering system. In some embodiments, the third party may transfer (or otherwise make available) the file(s) embodying the creative work directly to the new NFT owner's rendering machine. Once the file(s) embodying the creative work are transferred and/or otherwise made available to the rendering system or the new NFT owner's rendering machine (either directly or via a software agent associated with the new NFT owner), the file(s) associated with creative work can then be used to render the creative work for the new NFT owner, pursuant to any constraints or limitations on rendering (e.g., any of the constraints or limitations described herein).

In some embodiments, the transfer of the file(s) embodying the creative work and associated with the NFT from the third party to the new NFT owner (or to the new NFT owner's software agent and/or the new NFT owner's rendering machine) may be performed using a network 108 as previously described and shown in FIG. 1.

Optionally, at 413, some embodiments include the third party indicating that the file(s) embodying the creative work have been provided to an NFT owner (including perhaps how many times the file(s) was/were provided to an NFT owner and/or which NFT owners the file(s) was/were provided to) in a way that a future owner of the NFT 106 can verify which past NFT owners received the file(s) embodying the creative work and/or used the file(s) to render the creative work.

In one embodiment, the contents of the file associated with the NFT and the creative work are unknown (or secret) until the owner decrypts the file associated with the NFT and its associated creative work and/or uses the file to physically render the creative work. One example is analogous to buying a pack of baseball cards. “ ” Just like a purchaser of the pack of baseball cards does not know which cards will be contained in the pack until the purchaser opens the pack, in some embodiments, the creative work associated with the NFT may be unknown to the NFT purchaser until after the NFT has been purchased and the NFT owner uses the implementation file associated with the NFT to render the creative work.

In another example, a piece of digital creative work may include multiple media files or instructions guiding conversion to a physical piece. For example, a print, paint, and cut creative work may include painting as a manual intermediate step that is connected between two pieces of digital information controlling other parts of the creation of a physical piece (print and cut). The digital embodiment of the creative work may first be converted to a physical embodiment of the creative work by printing one layer (e.g., on a canvas or other material). A purchaser could then follow directions from the file embodying the creative work to paint the physical copy. The physical creative work could then be cut out by a rendering machine. In this example, there could exist three NFTs that represent the different steps (print, paint, and cut) independently, as well as a possible fourth NFT for the overarching instructions. Alternatively, there may be one NFT covering all steps, and separate encoding keys for each individual step, such that each step being released may be controlled.

Some artists or other creators may gain notoriety and fame under pseudonyms or permanent identity secrecy. In some embodiments, a system may protect the creator's privacy by extending Zero-Knowledge Proofs (e.g., with a system like zero knowledge succinct non-interactive argument of knowledge (zkSNARK)) for proving ownership of a file embodying a creative work. This would allow the creator to create and submit a file embodying a creative work to a location that is referenced by an NFT with provable ownership while protecting their identity. In operation, the above-described zkSNARK procedure can be used to authenticate a creator and/or an NFT owner in connection with any of the methods and processes disclosed herein.

Although some files referred to by an NFT may be encrypted, the NFT might contain an alternate version or “preview” link which can be used for verification, or for the enjoyment of others. Some example characteristics of the preview link include low-resolution image or video that is viewable by anyone, so it may be known what the NFT refers to; watermarked images or video; missing information such as missing pixels, etc.; and/or limited fabrication capability (e.g., can only be printed on paper, not the desired material used to create the original object or creative work).

In one example, a higher quality preview may be provisioned and allowed to be shown a limited number of times by an authorized previewer or escrow agent that takes measures to prevent the higher quality version from being duplicated. The preview may include multiple types of reconstructions, including 3D reconstructions for viewing in various virtual environments (e.g., second life, holodeck, hologram, etc.).

A NFT's creator may elect to have the work referenced in an NFT, to the extent possible, automatically decrypted and made readable to all parties to facilitate its entrance into the public domain on a specified date. For example, this date may be a fixed date, a specified duration beyond the last trade, a specified duration beyond a rendering date, a specified duration beyond a “canary” or other data item (e.g., another NFT or other data file associated with and/or manipulated via a smart contract) being updated on-chain, or another specified date.

A creative work having expiring access may be implemented. This concept is similar to the automatic public domain entry mechanism described previously (e.g., the “dead man's switch”), but where the one or more files embodying a creative work associated with an NFT become unusable (e.g., by destruction of the decryption key or deletion of the file), or returned to a previous seller or the original creator, (e.g., by a smart contract transferring ownership), after a specified deadline. This allows a creator the ability to lease access to renderers of creative works in a time-limited fashion.

In another example, a contract may expire if the creative work is not rendered at all or, alternatively, not rendered regularly. For example, a contract may expire if the creative work is not rendered every day/week/month/etc. This may be used to encourage consistent (e.g., regular) rendering of NFT-linked creative works.

Today there are many examples of creative works that are combined and/or remixed to produce a new creative work (e.g., sampled music, etc.). To address this behavior, the NFT might contain a remix option (e.g., along with certain contractual requirements) that allows the file embodying the creative work linked to by the NFT to be remixed with one or more other files embodying other creative works. In one example, the remixed creative work option may specify that the physical rendering of the creative work may or may not be combined with other creative works during the physical rendering stage. If the remix option is chosen by a creator not to allow combining and/or mixing, then the rendering machine tasked with printing or otherwise rendering the creative work may be prohibited from rendering a creative work according to an implementation file that is different in any way from the original implementation file associated with the NFT. For example, in embodiments that include a printing escrow agent tasked with printing or otherwise rendering the creative work, the printing escrow agent would be obligated to not allow any modifications during the rendering stage. In another example, a rendering machine tasked with rendering the creative work associated with the NFT can check that the implementation file for rendering the creative work is identical in all material respects to the implementation file associated with the NFT by performing a hash, checksum, or similar method for checking whether a digital file has been altered.

In another example, the remixed creative work option may specify that the remixed creative work may or may not be combined with other creative works into a new file referenced by a new NFT. As part of this option, the contract may require that certain legal rights and/or transaction fees associated with the original NFT are carried over to the new “remixed creative work” NFT. For example, one requirement could be that the original creator is credited with any new creative work that the original creative work is remixed into. In another example, the original creator may be entitled to receive a portion of any future transaction fee that is made from selling files or NFTs related to the original creative work. For example, a first NFT may include a link to “kitten art”, while a second NFT may include a link to a keychain design. A third NFT may combine the links to the two creative works to enable production of a kitten keychain.

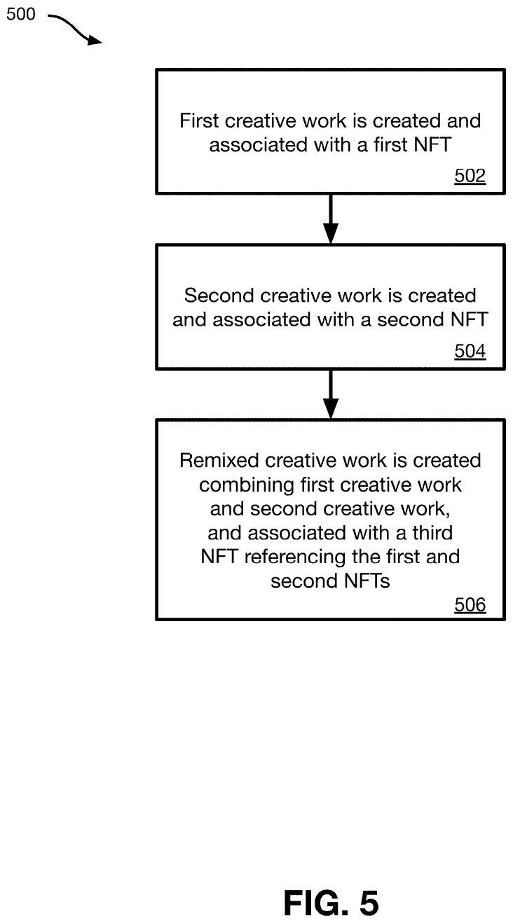

FIG. 5 is a flowchart illustrating aspects of some embodiments of processes for generating remixed creative works. In the NFT process 500 shown in FIG. 5, at 502 a first creative work is created by a creator and associated with a first NFT. At 504, a second creative work is created and associated with a second NFT. The second creative work may be created by the same creator as the first creative work, or by a different creator.

Some embodiments may additionally include verifying that remixing has been authorized for both the first creative work associated with the NFT and the second creative work associated with the second NFT. For example, in some embodiments, the NFT associated with the creative work may include an indication in the NFT metadata as to whether remixing of the creative work has been authorized, and if so, what constraints, limitations, and/or conditions (if any) have been placed on remixing the associated creative work with other creative works. In some embodiments, an indication of whether remixing is authorized (and any corresponding constraints, limitations, and/or conditions on remixing) may be included directly within the NFT metadata. In some embodiments, the NFT metadata may contain a link to another datafile (located on or off the blockchain) that may include the remixing authorization status and any of the constraints, limitations, and/or conditions.

Examples of constraints or limitations on how the creative work associated with the NFT can be used for remixed works may include (i) limiting how many other creative works can be used in an individual remixed work with the creative work associated with the NFT (e.g., this creative work associated with the NFT can be used to create a remixed work containing a combination of no more than 3 creative works in total), (ii) limiting the set of other creative works that can be used to generate a remixed work (e.g., this creative work associated with the NFT can only be remixed with other creative works created by the same creator; this creative work associated with the NFT can only be remixed with other creative works created by one or more other creators authorized by the creator; and/or this creative work associated with the NFT can only be remixed with other creative works within a specific collection or set of creative works), (iii) limiting how many unique remixed works can be generated with this creative work associated with the NFT (e.g., this creative work associated with the NFT can be used in no more than five unique remixed works), and/or (iv) any other limitations and/or constraints that an original creator can place on how the creative work associated with the NFT can be used for creating a remixed work.

Examples of conditions on using the creative work associated with the NFT for remixed works may include (i) requiring the creator of the remixed work to acknowledge the original creator of the creative work associated with the NFT as a co-creator of the remixed work by virtue of the original creator's work appearing as a component of the remixed work, (ii) requiring the creator of the remixed work to compensate the original creator of the creative work associated with the NFT for the remix creator's use of the original creator's creative work, and/or (iii) any other condition that an original creator can place on how the creative work associated with the NFT can be used for creating a remixed work.

Next, at 506, a remixed creative work is created, which combines the first creative work and the second creative work (subject to any applicable limitations, constraints, or conditions), and a third NFT is associated with the remixed creative work. In some embodiments, the third NFT may reference the first NFT and the second NFT, and the creator or creators of the first and second creative works may retain rights to the original creative works and perhaps to the remixed creative work, too. In some embodiments, the original creator or creators of the first and second creative works may additionally receive a portion of transaction fees resulting from or relating to the remixed creative work.

In some embodiments, as soon as an NFT is purchased, the buyer becomes a seller again, whether they desire to sell the NFT or not. Imagine an artist who always wants their art to be available, albeit at a higher price. For example, an NFT may always be tradable until the creative work associated with the NFT is physically rendered. For example, if the creative work is printed or otherwise rendered, then that printing/rendering could be the terminus of its trading life. In another example, a trusted screen may display the creative work associated with the NFT only as long as a specific person owns the NFT associated with the creative work. This could enable a circumstance where someone writes software to always provide the top bid so they never lose control of the asset or its enjoyment.

Limitations may be put in place (e.g., using one or more smart contracts) such that the market availability for an NFT ends when the file associated with the creative work(s) associated with an NFT changes in some way (e.g., the creative work has been rendered), after a certain number of transactions of the NFT has been made, after a certain price has been paid for the NFT, after a certain time has elapsed, etc. When time is used for a limitation, it may effectively create an auction for the creative work associated with the NFT. The owner of the NFT after a time period ends has effectively won the auction for the creative work(s) associated with the NFT, and thus, the NFT owner at that time is no longer compelled to list or otherwise offer the NFT for sale. There may also be variations where a time delay is introduced before the NFT is forced onto the market so that the purchaser can enjoy it for a fixed period of time before the NFT becomes available on the market.

Other example embodiments may include a minimum bid increment. For example, in an auction context, the next bidder may be required to bid a penny more, $100 more, 1% more, or a more complex function such as a decreasing amount that drops with time. The value of the required bid may be calculated as an amount of cryptocurrency or a number of translated currency units such as dollars. This might be attractive to a creator who wants ownership of their work to change over time. In some examples, the minimum bid could even drop such that if nobody is bidding on the creative work associated with the NFT, the NFT drops in price to become more affordable. In another example, the minimum bid for the NFT might drop as the number of prints/renderings of the creative work associated with the NFT increases.

In some examples, there may be competition to purchase the NFT or the creative work associated with the NFT as soon as it becomes available. In this case, an auction might be used where multiple bids could be made and only the highest would be accepted, rather than the NFT changing hands among several buyers/sellers during subsequent bidding.

Additional embodiments build on embodiments described herein to allow a creator to securely sell to a buyer a unique physical piece embodying a creative work without physically transporting the creative work.

For example, a chain of custody NFT (which might be a vouched chain of custody NFT) may have the following escrow instructions: the file embodying a creative work may not be distributed digitally, but may be used to render the creative work in physical form once. This may be implemented, for example, by a “printing escrow agent” such as a machine that can create a physical copy of the creative work while respecting the chain of custody. In this example, the printing escrow agent could be, for example, a printing machine or printing company that operates printing machines. When ownership/control of the NFT is (at least temporarily) transferred to the printing escrow agent for the purpose of printing the creative work (or ownership of the NFT is otherwise verified by the printing escrow agent), the escrow agent decrypts the file embodying the creative work, creates a physical copy of the work (e.g. by inkjet printer, 3D printer, or other rendering machine), and then prevents making of further copies (and may delete the original file and decryption key). This ensures that the original digital file embodying the creative work is lost forever, and only the physical rendering of the creative work remains. The NFT may remain as a “concert ticket stub,” without the ability to physically render the creative work from the files linked to by the NFT. In this manner, a limited edition good may be created by a creator, distributed through intermediaries, bought and resold digitally, and finally delivered in physical form to its ultimate owner, similar to digital rights management (DRM) where physical goods can be distributed digitally. This type of NFT implementation where a user can purchase an NFT and then print/render a physical/tangible rendering of a creative work is sometimes referred to herein as a “transporter NFT” because it allows/enables a physical/tangible creative work (or other tangible good) to be transported to the NFT owner, i.e., by allowing the NFT owner to either render the creative work on his or her own machine, or arrange for a print/render escrow agent to print/render the creative work (or other good) and deliver the printed/rendered work/good to the NFT owner.

In another implementation, the file embodying a creative work linked to by the NFT might have a limited number of “prints” or “renders” available. Each time the rendering escrow agent creates/renders a physical copy of the creative work, the number of prints/renderings available decrements by one. When the number of available prints/renderings reaches zero, the rendering escrow agent can no longer create prints/renderings. In this way, the NFT can be bought and resold for “printing” until the number of “prints” runs out. Fail safes or other contingencies may be included for situations where there is an issue or failure during the reproduction process allowing for a re-print if it is verified that the print was a failure.

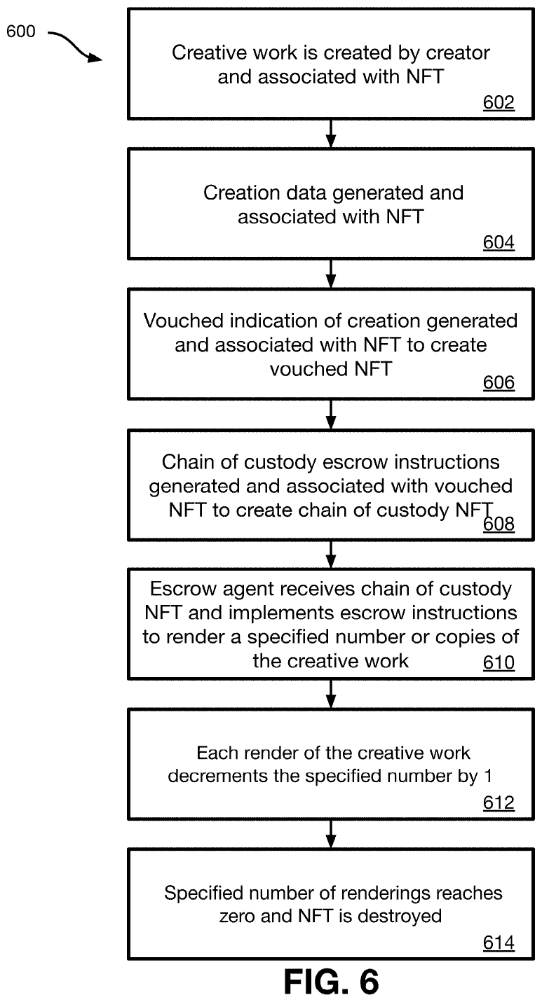

FIG. 6 is a flowchart illustrating aspects of some embodiments of processes for limiting the total number of printings/renderings of a creative work associated with an NFT. In the NFT process 600 shown in FIG. 6, at 602 a creative work is created by a creator and associated with an NFT. At 604, creation data is generated and associated with the NFT as described previously. At 606, a vouched indication of creation is generated and associated with the NFT to create a vouched NFT as described previously. At 608, chain of custody escrow instructions, such as for example a limited number of renderings or “prints” of the creative work, are generated and associated with the vouched NFT to create a chain of custody NFT. This may be done, for example, using a smart contract associated with the NFT, using a third party escrow agent to store the information, and/or using a program, entity, and/or company hosting all the intelligence and actions that merely reference the NFT. At 610, an escrow agent receives the chain of custody NFT (or at least temporarily obtains ownership or control of the NFT for the purpose of rendering the creative work associated with the NFT) and implements the escrow instructions regarding, for example, the specified limited number of renderings allowed of the creative work. At 612, each rendering of the creative work decrements the specified limited number of renderings by one. Finally, at 614, once the specified limited number of renderings reaches zero (i.e. all allowed renderings have been rendered) the NFT and/or the implementation file(s) for rendering the creative work associated with the NFT are destroyed and no further renderings are possible.

In one example, the escrow agent can add a verification step prior to providing access to the owner of the rendered creative work. For example, the escrow agent can view the end result (e.g., using cameras and vision techniques) and compare (e.g., visually) the result to expectations, and offer the ability to destroy (e.g., shred, cut, burn, etc.) the rendered creative work in order to recover the print allowance.

For example, the rendering machine may use its embedded cameras and software to capture one or more photos of the reproduced creative work and visually compare the end result with an expected result. The expected result may be provided by the NFT itself (e.g., via reference images linked to in the metadata of the NFT) or it may be determined by the rendering machine in advance of the printing process; for example, incorporating not just the creative work but also the material used for the printing process in determining the expected result. Additionally and/or alternatively, the expected result may be indicated by the NFT owner who authorized the printing. In this example, the ability to destroy the print and recover the print allowance may be constrained, for example, by a condition of the machine such that the decision to destroy the creative work must happen before the user is allowed to open the lid and access the material (otherwise, verification succeeds and the print is considered valid and un-replaceable), or by the ability of the machine to identify or recognize the creative work if it has been removed and replaced in the machine (e.g., the user only identified the failure after removing the creative work from the machine). The enforceability of these and other conditions may require monitoring of various machine states to make sure the machine isn't modified to circumvent any of these conditions. For example, accelerometers, lid switches, cameras, photo sensors, or the like may be used to detect or prevent tampering with the machine or to make sure the machine is not moved and/or the lid is not opened, to circumvent enforcement of limiting print conditions.

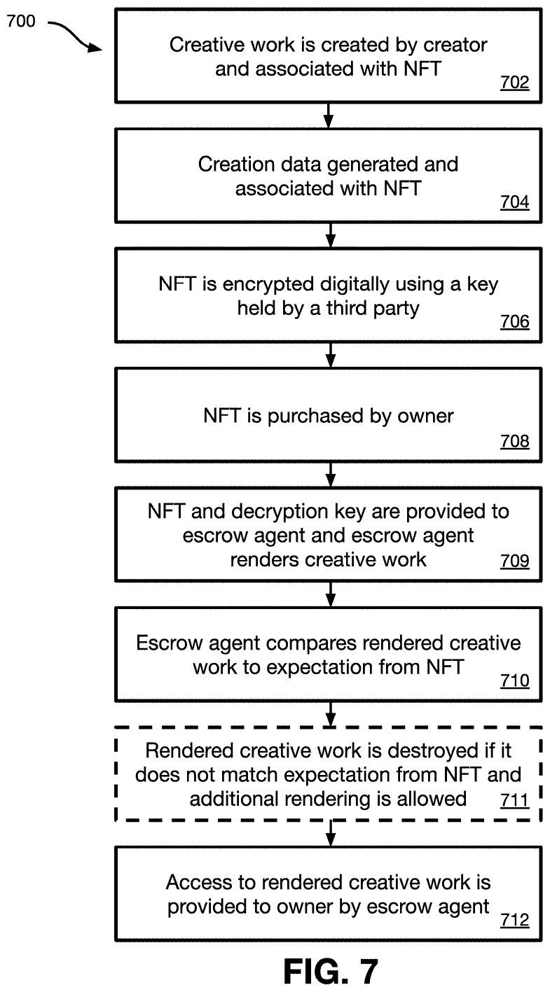

FIG. 7 is a flowchart illustrating aspects of some embodiments of processes for verifying whether a printing/rendering of a creative work associated with an NFT was successful. In the NFT process 700 shown in FIG. 7, at 702 a creative work is created by a creator and associated with an NFT. At 704, creation data is generated and associated with the NFT. At 706, one or more files associated with the NFT are digitally encrypted using a key held by a third party, e.g., implementation file(s), creation data, etc. At 708, the NFT is purchased by an owner. At 709, the one or more files associated with the NFT and a decryption key are provided to an escrow agent, and the escrow agent may render the creative work associated with the NFT. At 710, the escrow agent compares the actual rendering of the creative work to the expected rendering of the creative work (e.g., by comparing images of the actual rendering to reference images depicting the expected rendering) to verify whether the creative work associated with the NFT was rendered properly. Optionally, at 711, if the actual rendering of the creative work does not match the expected rendering of the creative work (i.e., the creative work has not rendered properly), the actual rendering of the creative work that was determined to be unsatisfactorily rendered may be destroyed and an additional rendering may be allowed. At 712, the owner is provided access to the rendered creative work by the escrow agent.

Additionally or alternatively, failed prints may be recorded in one or more files associated with the NFT, along with documentation of the failure (e.g., a photo of the damaged print), and additional prints then allowed. If the NFT owner abused the reprinting capability by claiming a damaged print and reprint when it was not true, doing so would diminish the resale value of the NFT or possibly void subsequent print allowances.

Thus, a creator may sell a creative work as a limited-edition distribution, but with an option to allow the current owner of an NFT linking to a file embodying the creative work to remove that restriction, with a possible resulting decrease in value of the creative work (but increase in number of physical embodiments of the creative works) that results.

In other embodiments, a validated NFT print may be created, which is a print properly made from a chain of custody NFT. For example, when a physical embodiment of a work associated with a chain of custody NFT is correctly printed, the printing escrow agent may update one or more files linked to by the NFT with the information that a print was made. Alternatively, in some embodiments, the NFT metadata can be directly updated to reflect that a printing/rendering was completed. At the same time, the printing escrow agent may record information about the print such that the physical version has its own provable provenance such as the identity of the party that printed/rendered it, when it was printed/rendered, on what machine it was printed/rendered, a picture of the material before and after printing/rendering, a unique identifier identifying the material on which it was printed/rendered, or a serial or edition number included in the print/render.

In one example, a board of natural wood may be photographed at the factory, and a masking may be applied. A barcode can then be applied to the masking, either visibly or via ultraviolet-reactive ink, uniquely identifying that board. The photograph of that board may be connected to a unique code on a server (or in a blockchain storage mechanism). The current owner of a transporter NFT may then choose that piece of material at random for a validated NFT print. As described above, a validated NFT print is a print made from a chain of custody NFT. The material can then be inserted into a printer, which reads the barcode and identifies the piece of material by loading the factory photograph of the board as it appears underneath the masking. The user can preview the print as it will appear on the final board with the masking removed. The print can then be made, and the file linked to by the NFT can be updated with the information that a print was made, along with information on the printer, the user, the material it was printed on, the image of the material complete with wood-grain pattern, and a simulation of what the final print will look like. A photograph of the completed print (with masking in place) can be taken and added to or otherwise associated with the NFT before the material is removed from the printer (or other rendering machine), which captures additional information and adds to the file linked to by the NFT (e.g. if the material was physically damaged before or during the print, that would be visible). Finally, optionally, the user can remove the masking and add an image of the final print to the file linked to by the NFT. Now, another party considering the purchase of a validated NFT print can ensure it is not a forgery by comparing the natural (and unique) woodgrain of the material with the images of the rendered creative work on file and linked to by the NFT.

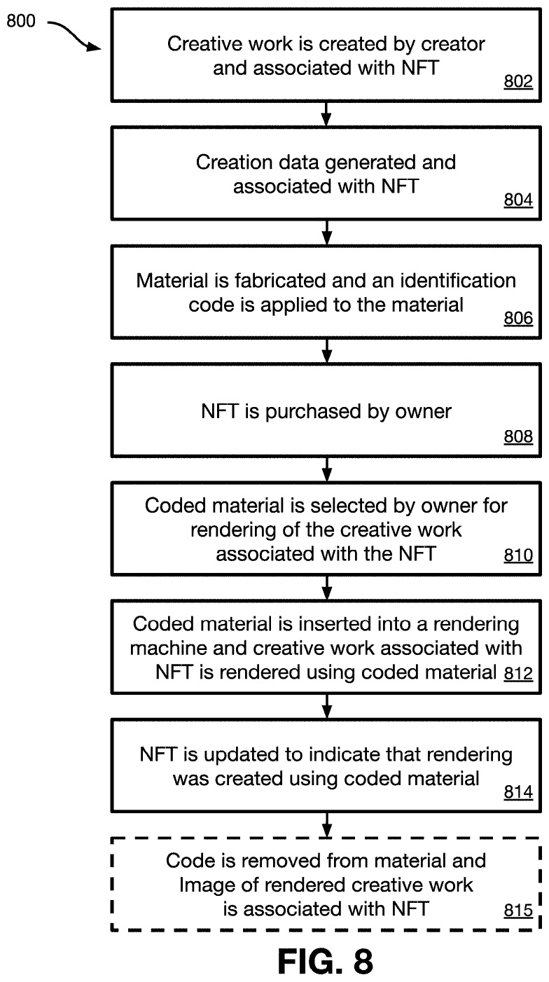

FIG. 8 is a flowchart illustrating aspects of some embodiments of processes for using coded materials in connection with rendering creative works associated with NFTs. In the NFT process 800 shown in FIG. 8, at 802 a creative work is created by a creator and associated with an NFT. At 804, creation data is generated and associated with the NFT. At 806, a material is fabricated and an identification code (e.g. visible or invisible barcode) is applied to the material. At 808, the NFT is purchased by an owner, and at 810, the coded material previously fabricated and containing the identification code is selected by the NFT owner for use in rendering the creative work associated with the NFT. At 812, the coded material is inserted into a physical renderer or rendering machine, and the creative work associated with the NFT is rendered using the coded material. At 814, the NFT is updated (or one or more files linked to the NFT are updated) to include data showing that a physical rendering of the creative work was made using the coded material. Optionally, at 815, the code may be removed from the coded material and an image of the physical rendering of the creative work may be associated with the NFT so that other parties considering purchasing the physical rendering of the creative work would be able to verify the originality of the physical rendering by comparing characteristics of the coded material to the final physical rendering.

“ ” In some embodiments, instead of a printing escrow agent generating a physical/tangible rendering of a creative work associated with an NFT (e.g., a transporter NFT), a “display escrow agent” generates an ephemeral rendering of a creative work associated with an NFT. A display escrow agent decrypts the file embodying a creative work on behalf of an NFT owner but does not make the file available. Instead, the display escrow agent renders the creative work associated with the NFT in an ephemeral manner that may be enjoyed, but only as long as the NFT owner retains ownership of the NFT. For example, the display escrow agent might decrypt a song and then play it via a speaker when requested by the NFT owner. But after the NFT owner has sold the NFT associated with the song, the display escrow agent can no longer access the audio file associated with the NFT, decrypt the audio file associated with the NFT, or play the audio file associated with the NFT. In another example, the display escrow agent may be a screen that displays a picture or movie, as long as the owner owns the NFT associated with the picture or movie. The NFT owner can enjoy the ephemeral physical manifestation of the creative work (i.e., the song or image on screen), but after the NFT owner sells the NFT, the NFT owner's ability to enjoy the creative work is revoked and becomes available to the new NFT owner provided that the new NFT owner has a display escrow agent to render the creative work associated with the NFT. This type of NFT is sometimes referred to herein as an “owner-benefit NFT” because the owner of the NFT enjoys the benefit of ephemeral rendering of the creative work associated with the NFT, but only while the NFT is owned.

Importantly, using owner-benefit NFTs in the manner described above requires reliable display escrow agents. It may be possible to implement the escrow agent capability in a smart contract itself, eliminating the need for a trusted party, for chain of custody NFTs. However, the creation of a vouched NFT requires a trusted partner ‘to verify/certify that the individual purporting to have created the creative work associated with the NFT did, in fact, create the creative work associated with the NFT. The transporter NFT may require the printing escrow agent be a trusted party. The owner-benefit NFT embodiment may require that the display escrow agent be trusted.

In some embodiments, a smart contract may transfer funds to various parties in response to certain conditions being met. For example, subsequent purchases of an NFT may cause the smart contract to send funds to any one or more of (i) the original creator of the creative work associated with the NFT, (ii) the party that vouched for the NFT creation, (iii) parties that operate escrow agents, either in aggregate or to specific escrow agents when they are used, and/or (iv) escrow agents that are responsible for the physical rendering of the creative work. In some examples, funds are proportional to the effort used to vouch for the NFT creation/rendering of the creative work and/or the volume of creation information that is stored (i.e., the amount of data stored). In other examples, funds transferred to an escrow agent or vouching party are proportional to a rating or standing associated with the escrow agent or vouching party. In another example, the smart contract may transfer funds to parties who use the funds for carbon offsets at certain times.

One challenge of intellectual property rights enforcement presented by NFTs is that, after NFTs associated with works are sold, works might be resubmitted for association with other NFTs with non-substantial modification. To address this challenge, NFT sale fees and royalties may be held in escrow using smart contracts, using an on-chain dispute resolution process with third-party arbitration. For example, works submitted by not-yet trusted content creators might have transaction funds held in escrow for the first 90 days, with the time limit increasing as disputes and appeals are made. The transaction can be finalized on the blockchain only after the escrow conditions have been met. This allows for proceeds to be held until the arbitration body or court decides the outcome of the contest. This is valuable because blockchain transactions are generally irreversible, while escrow events preceding the creation of blockchain-based transactions can be reversed before the transactions are placed on the blockchain.

In one example, a smart contract is used such that every time an embodiment of a creative work associated with an NFT is rendered or every time the NFT is transferred or at certain other defined times, a fee or a portion of a transaction fee associated with that NFT is transferred to offset the carbon footprint of the transaction, in a sort of social contract. This could be a fixed dollar sum, a fixed cryptocurrency sum, or a percentage of value or transaction cost, for example. This amount could go to a fixed recipient (e.g., a particular nonprofit) or could search for or identify a recipient from, for example, a trusted third party, and send the amount there (e.g. a nonprofit that specializes in identifying high-quality carbon offsets could list the crypto wallets of those addresses). This process could also be used for any kind of charitable donation. For example, an artist could create an NFT linked to a picture of a lion and put it up for bid with a contract that sends 1% to a wildlife charity every time the NFT changes hands.

In some embodiments, a standard for the NFT JavaScript Object Notation (JSON) payload may be created that indicates the author, a disclaimer, an intellectual property assignment, and so on, to enable the above social contract.

Files embodying creative works may be stored in a remote location (i.e., not stored on the blockchain), and the NFT can be provided with a pointer to the remote location where the file embodying the creative work has been stored. In some embodiments of the present invention, an NFT might contain the actual creative work, either in plaintext or encrypted or hashed as discussed previously. This may be more practical in a blockchain other than Ethereum (where most NFTs are currently stored), where storage can be prohibitively expensive. In another implementation, a second blockchain, such as a sidechain, an existing blockchain, or a custom-made blockchain, could store the creative work while the NFT points to, owns, or otherwise is connected to a corresponding NFT and/or address on that other blockchain.

As noted above, certain aspects of the inventive concepts described herein may be implemented using a CNC machine as the rendering device for reproducing a physical/tangible copy of a creative work associated with an NFT as described above. The following discussion of features of CNC machines, and specifically of laser CNC machines, are provided for context and are not to be considered limiting except to the extent that a claim requires specific features.

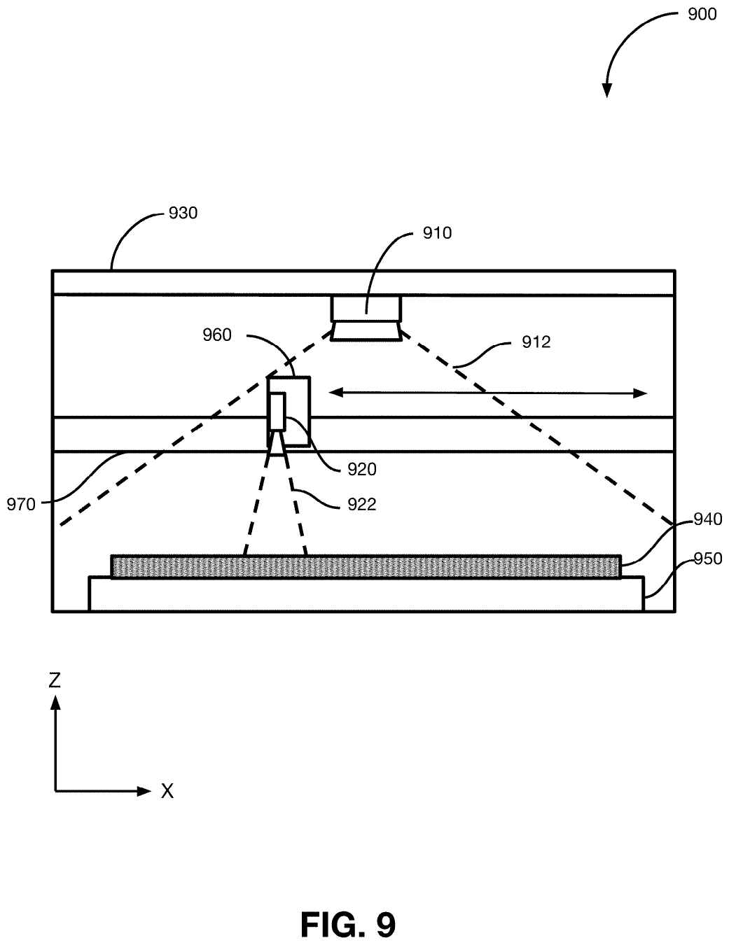

FIG. 9 depicts an elevational view of an example of a computer numerically controlled machine 900, consistent with implementations of the current subject matter. The example of the computer numerically controlled machine 900 shown in FIG. 9 includes a camera 910 positioned on the inside of a lid 930 of the CNC machine 900, where the camera 910 is configured to capture a field of view 912 sufficiently large to capture an image of an entire material bed 950 and/or at least the material 940 resting or otherwise placed on the material bed 950. Another camera 920 is positioned on a laser head 960 that is configured to move along a translation rail 970, where the camera 920 is configured to capture a field of vision 922 and obtain one or more images of at least portions of the material 940 resting or otherwise placed on the material bed 950, consistent with some implementations of the current subject matter. In operation, the cameras 910 and 920 may be used to capture one or more images of an actual physical/tangible rendering of a creative work for comparison with one or more reference images in connection with determining whether an actual rendering was performed sufficiently, as described herein.

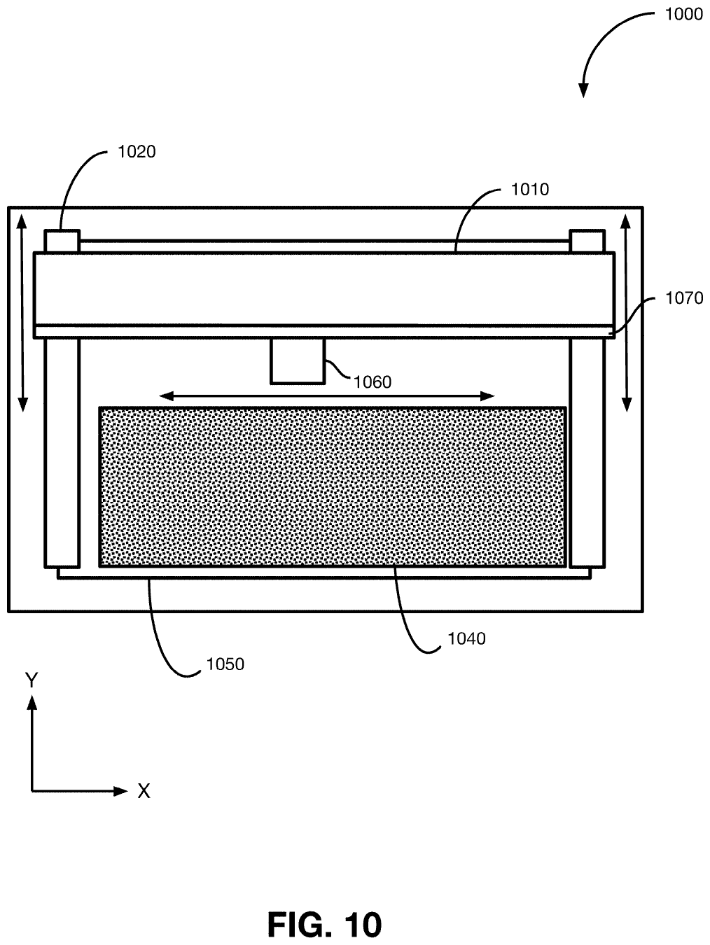

FIG. 10 depicts a top view of the example of the computer numerically controlled machine 1000, which is similar to or the same as CNC machine 900 shown in FIG. 9. The top view of the CNC machine 1000 depicted in FIG. 10 shows a laser head 1060 (which may also include or accommodate a camera, e.g., camera 920 in FIG. 9) arranged to move back-and-forth in the x-direction via a translation rail 1010 that is arranged to move in the y-direction along a dual-rail arrangement 1020. In operation, moving the laser head 1060 in the x-direction via the translation rail 1010 and moving the translation rail 1010 in the y-direction via the dual-rail arrangement 1020 enables the CNC machine 1000 to position the laser head (and any camera incorporated therein or affixed thereto, e.g., camera 920 in FIG. 9) over the material 1040 at any position over the material bed 1050.

As noted above, in an illustrative but non-limiting implementation of the current subject matter, the computer numerically controlled machine 900 may be a laser cutter/engraver that uses electromagnetic energy (e.g., laser) to perform various forms of subtractive processing including, for example, cutting, engraving, and/or the like. It will be apparent to one of ordinary skill in the art based on the current disclosure that various features described below can be implemented with other types of computer numerically controlled machines. The computer numerically controlled machine 900 can be, for example, a lathe, an engraver, a 3D printer, a milling machine, a drill press, a saw, and/or the like.

As a laser cutter/engraver, the computer numerically controlled machine 900 may be subject to particularly challenging design constraints. For example, a laser cutter/engraver is subject to regulatory guidelines that restrict the egress of electromagnetic energy from the unit when operating, making it challenging for light to enter or escape the unit safely, for example to view or record an image of the contents. The beam of a laser cutter/engraver must be routed from the emitter to the area to be machined, potentially requiring a series of optical elements such as lenses and mirrors. The beam of a laser cutter/engraver is easily misdirected, with a small angular deflection of any component relating to the beam path potentially resulting in the beam escaping the intended path, potentially with undesirable consequences. A laser beam may be capable of causing material destruction if uncontrolled. A laser cutter/engraver may require high voltage and/or radio frequency power supplies to drive the laser itself.

Liquid cooling is common in laser cutter/engravers to cool the laser, requiring fluid flow considerations. Airflow is important in laser cutter/engraver designs, as air may become contaminated with byproducts of the laser's interaction with the material such as smoke, which may in turn damage portions of the machine for example fouling optical systems. The air exhausted from the machine may contain undesirable byproducts such as, for example, smoke that must be routed or filtered, and the machine may need to be designed to prevent such byproducts from escaping through an unintended opening, for example by sealing components that may be opened. Unlike most machining tools, the kerf—the amount of material removed during the operation—is both small and variable depending on the material being processed, the power of the laser, the speed of the laser, and other factors, making it difficult to predict the final size of the object.

Also unlike most machining tools, the output of the laser cutter/engraver is very highly dependent on the speed of operation; a momentary slowing can destroy the workpiece by depositing too much laser energy. In many machining tools, operating parameters such as tool rotational speed and volume of material removed are easy to continuously predict, measure, and calculate, while laser cutter/engravers are more sensitive to material and other conditions. In many machining tools, fluids are used as coolant and lubricant; in laser cutter/engravers, the cutting mechanism does not require physical contact with the material being affected, and air or other gasses may be used to aid the cutting process in a different manner, by facilitating combustion or clearing debris, for example.

Referring again to FIG. 9, the computer numerically controlled machine 900 can have a housing surrounding an enclosure or interior area defined by the housing. The housing can include walls, a bottom, and one or more openings to allow access to the computer numerically controlled machine 900. In addition, the material bed 950 may be disposed at least partially within the housing of the computer numerically controlled machine 900 and may include a top surface on which the material 940 generally rests.

In the example of the computer numerically controlled machine 900 shown in FIG. 9, the computer numerically controlled machine 900 can also include an openable barrier as part of the housing to allow access between an exterior of the computer numerically controlled machine and an interior space of the computer numerically controlled machine. The openable barrier can include, for example, one or more doors, hatches, flaps, lids, and the like that can actuate between an open position and a closed position. The openable barrier can attenuate the transmission of light between the interior space and the exterior when in a closed position. Optionally, the openable barrier can be transparent to one or more wavelengths of light or be comprised of portions of varying light attenuation ability. One type of openable barrier can be a lid 930 that can be opened or closed to put material 940 on the material bed 950 on the bottom of the enclosure.

Various example implementations discussed herein include reference to a lid. It will be understood that absent explicit disclaimers of other possible configurations of the operable barrier or some other reason why a lid cannot be interpreted generically to mean any kind of openable barrier, the use of the term lid is not intended to be limiting. One example of an openable barrier can be a front door that is normally vertical when in the closed position and can open horizontally or vertically to allow additional access. There can also be vents, ducts, or other access points to the interior space or to components of the computer numerically controlled machine 900. These access points can be for access to power, air, water, data, etc. Any of these access points can be monitored by cameras, position sensors, switches, etc. If they are accessed unexpectedly, the computer numerically controlled machine 900 can execute actions to maintain the safety of the user and the system, for example, a controlled shutdown. In other implementations, the computer numerically controlled machine 900 can be completely open (i.e. not having a lid 930, or walls). Any of the features described herein can also be present in an open configuration, where applicable.

The computer numerically controlled machine 900 can have one or more heads including, for example, the head 960, which can be operated to alter the material 940. The head 960 may be configured to steer a beam of electromagnetic energy to a desired location on the material 940 positioned in the working area of the computer numerically controlled machine 900. For instance, the head 960 may be mobile including by translating and/or rotating to locate a beam of electromagnetic energy from a source configured to generate and/or emit the electromagnetic energy. Alternatively, the head 960 may be stationary and the beam of electromagnetic energy may be located by translating and/or rotating one or more optical components configured to route the electromagnetic energy from the head 960. It should be appreciated that the computer numerically controlled machine 900 may include multiple heads that operate independently or in unison to locate the beam of electromagnetic energy.

In some implementations of the current subject matter, the head 960 can be configured to include a combination of optical, electronic, and/or mechanical components that can, in response to commands, cause a laser beam or electromagnetic energy to be delivered to cut or engrave the material 940. The source (e.g., an emitter and/or the like) generating the electromagnetic energy may be part of the head 960 or separate from the head 960. The computer numerically controlled machine 900 can also execute operation of a motion plan for causing movement of the head 960 in implementations where the head 960 is configured to be mobile. Electromagnetic energy effecting one or more changes in the material 940 that is at least partially contained within the interior space of the computer numerically controlled machine 900 may therefore be delivered by moving the head 960. In one implementation, the position and orientation of the optical elements inside the head 960 can be varied to adjust the position, angle, or focal point of a laser beam. For example, mirrors can be shifted or rotated, lenses translated, etc. The head 960 can be mounted on a translation rail 970 that is used to move the head 960 throughout the enclosure. In some implementations the motion of the head 960 can be linear, for example on an X axis, a Y axis, or a Z axis. In other implementations, the head 960 can combine motions along any combination of directions in a rectilinear, cylindrical, or spherical coordinate system.

A working area for the computer numerically controlled machine 900 can be defined by the limits within which the head 960, whether stationary or mobile, can cause delivery of a machining action, or delivery of a machining medium, for example electromagnetic energy. The working area can be inside the interior space defined by the housing. It should be understood that the working area can be a generally three-dimensional volume and not a fixed surface. For example, if the range of travel of a vertically oriented laser cutter is a 20″×20″ square entirely over the material bed 950, and the laser from the laser beam comes out of the laser cutter at a height of 4 inches above the material bed of the computer numerically controlled machine, that 400 square-inch volume can be considered to be the working area.

The working area can be defined by the extents of positions in which material 940 can be worked by the computer numerically controlled machine 900. As such, the boundaries of the working area may not necessarily be defined or limited by the range of travel of any one component. For example, if the head 960 could turn at an angle, then the working area could extend in some direction beyond the travel of the head 960. By this definition, the working area can also include any surface, or portion thereof, of any material 940 placed in the computer numerically controlled machine 900 that is at least partially within the working area, if that surface can be worked by the computer numerically controlled machine 900. Similarly, for oversized material, which may extend even outside the computer numerically controlled machine 900, only part of the material 940 might be in the working area at any one time.

The translation rail 970 can be any sort of translating mechanism that enables movement of the head 960 in the X-Y direction, for example a single rail with a motor that slides the head 960 along the translation rail 970, a combination of two rails that move the head 960, a combination of circular plates and rails, a robotic arm with joints, etc.

Components of the computer numerically controlled machine 900 can be substantially enclosed in a case or other enclosure. The case can include, for example, windows, apertures, flanges, footings, vents, etc. The case can also contain, for example, a laser, the head 960, optical turning systems, cameras, the material bed 950, etc. To manufacture the case, or any of its constituent parts, an injection-molding process can be performed. The injection-molding process can be performed to create a rigid case in a number of designs. The injection molding process may utilize materials with useful properties, such as strengthening additives that enable the injection molded case to retain its object when heated, or absorptive or reflective elements, coated on the surface or dispersed throughout the material for example, that dissipate or shield the case from laser energy. As an example, one design for the case can include a horizontal slot in the front of the case and a corresponding horizontal slot in the rear of the case. These slots can allow oversized material to be passed through the computer numerically controlled machine 900.

Optionally, there can be an interlock system that interfaces with, for example, the openable barrier, the lid 930, door, and the like. Such an interlock is required by many regulatory regimes under many circumstances. The interlock can then detect a state of opening of the openable barrier, for example, whether a lid 930 is open or closed. In some implementations, an interlock can prevent some or all functions of the computer numerically controlled machine 900 while an openable barrier, for example the lid 930, is in the open state (e.g. not in a closed state). The reverse can be true as well, meaning that some functions of the computer numerically controlled machine 900 can be prevented while in a closed state. There can also be interlocks in series where, for example, the computer numerically controlled machine 900 will not operate unless both the lid 930 and the front door are both closed. Furthermore, some components of the computer numerically controlled machine 900 can be tied to states of other components of the computer numerically controlled machine, such as not allowing the lid 930 to open while the laser is on, a movable component moving, a motor running, sensors detecting a certain gas, etc. In some implementations, the interlock can prevent emission of electromagnetic energy from the head 960 when detecting that the lid 930 is not in the closed position.

The head 960 of the computer numerically controlled machine 900 may deliver, to the material 940 disposed on the material bed 950, an electromagnetic energy to effect one or more changes in the material 940. The one or more changes in the material 940 may include a removal of one or more portions of the material 940, which may be achieved by one or more cuts that partially and/or fully penetrate the material 940. In some example embodiments, the one or more changes may correspond to a design formed by combining two or more objects. For example, the one or more changes may correspond to a design formed by applying, to the two or more objects, one or more Boolean operations such as union, subtraction, intersection, difference and/or the like. Alternatively and/or additionally, the one or more changes may correspond to a three-dimensional treatment applied to one or more edges along a perimeter of the material 940. Examples of edge treatments may include a chamfer (e.g., a sloped or angled edge) and a fillet (e.g., a rounded or smooth edge), which may be achieved by delivering electromagnetic energy to create a variable depth engraving along at least a portion of the perimeter of the material 940.

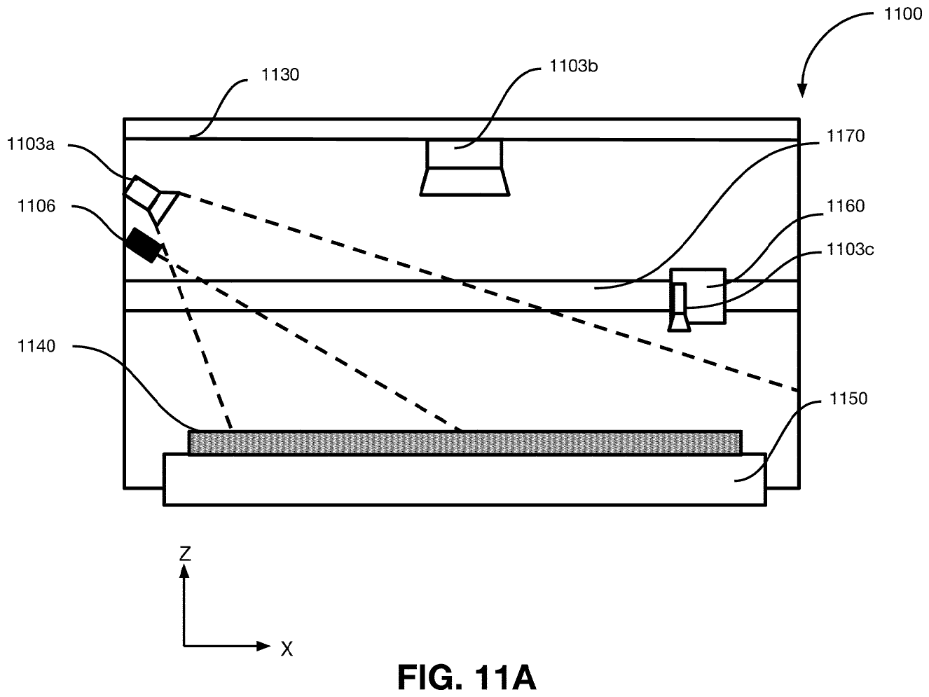

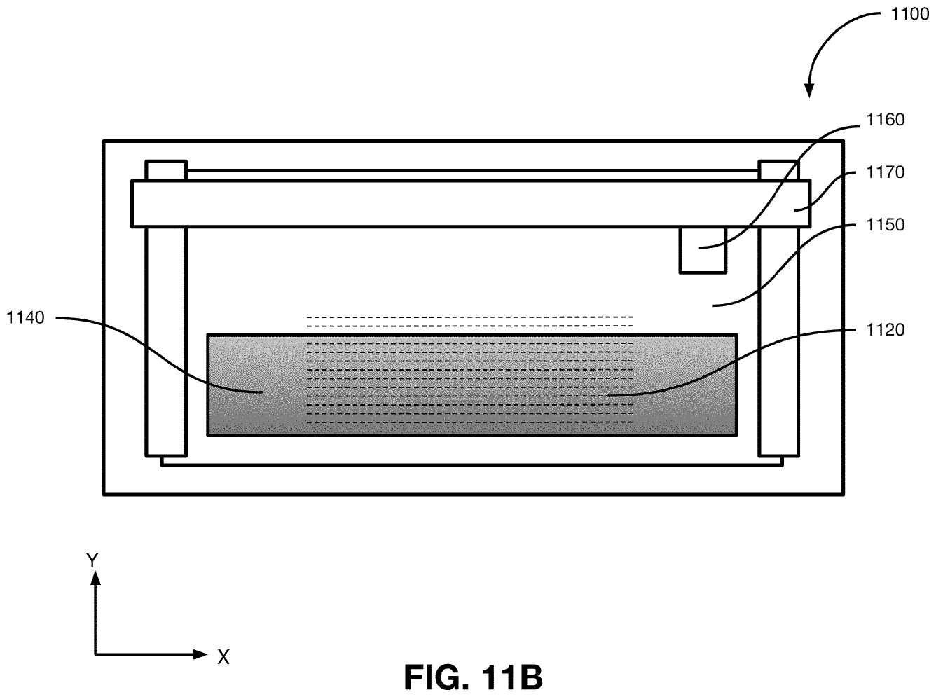

FIGS. 11A and 11B show a CNC machine 1100 according to some alternative embodiments. CNC machine 1100 may be the same as or similar to CNC machine 900 (FIG. 9) and/or CNC machine 1000 (FIG. 10).

FIG. 11A shows a side view of the CNC machine 1100. CNC machine 1100 includes a first camera 1103a, a second camera 1103b, and a third camera 1103c. The first camera 1103a is mounted in an interior corner of the CNC machine 1100 and configured to capture images of material 1140 placed upon the material bed 1150 of the CNC machine 1100. The first camera 1103a may be fixed or moveable. The second camera 1103b is mounted to the inside of the lid 1130 of the CNC machine 1100 and configured to capture images of material 1140 placed upon the material bed 1150 of the CNC machine 1100. The third camera 1103c is mounted to the laser head 1160. Because the laser head 1160 is movable in the x-direction along the translation rail 1170, the third camera 1103c integrated therewith or mounted thereto is likewise movable in the x-direction along the translation rail 1170 so that the third camera 1103c can be positioned at various locations over the material 1140 to obtain images of the material 1140. CNC machine 1100 also includes a sensor 1106 (e.g. a laser detector or other sensor) that is configured to measure aspects, e.g., the height or thickness, of the material 1140 placed on the material bed 1150 and/or the characteristics of cuts and/or engravings made during rendering. These measured characteristics captured by the sensor 1106 can be used in combination with the images captured by the three cameras 1103a-c to help determine whether a rendering was completed successfully.

FIG. 11B shows an overhead view of the CNC machine 1100. The overhead view shows the laser head 1160, which includes the second camera 1103b. The laser head 1160 and the second camera 1103b are movable in the x-direction along the translation rail 1170, which is itself movable in the y-direction via dual-rail arrangement comprising rails on each side of the CNC machine 1100. In operation, the second camera 1103b can be moved to any x-y position to capture regions 1120 of the material 1140 resting on the material bed 1150.

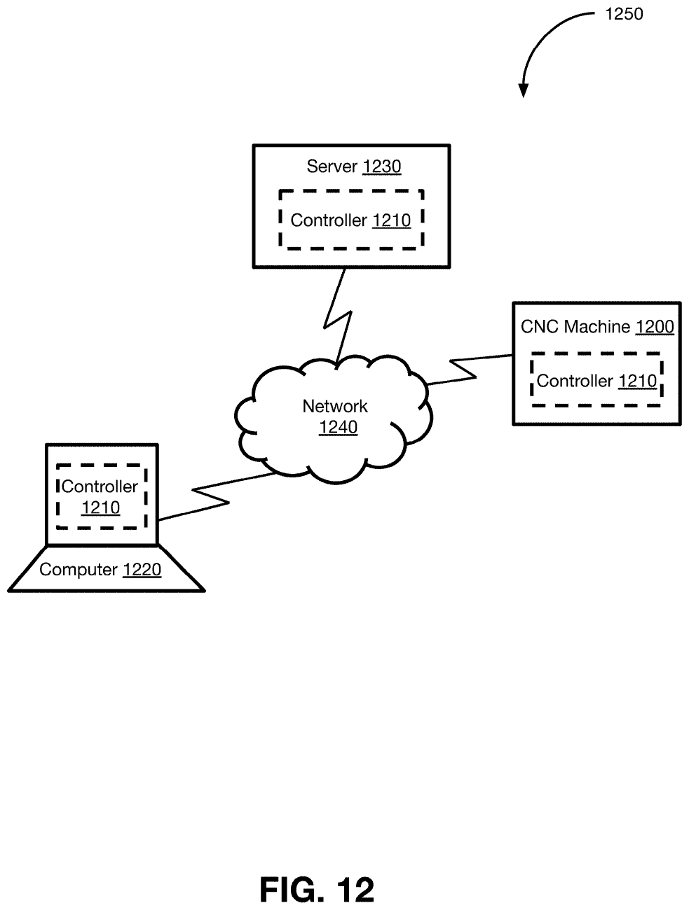

FIG. 12 depicts a block diagram illustrating an example of a computer numerically controlled processing system 1250 (sometimes referred to herein as a rendering system) consistent with some implementations of the current subject matter. The rendering system 1250 includes a CNC machine 1200 (or similar rendering machine), a computer 1220 (or other controller device configured to control and/or communicate with the CNC machine 1200), and a cloud-based rendering server 1230. The controller 1210 function may reside in any one or more of the CNC machine 1200 (or rendering machine), computer 1220 (or controller device), or cloud server 1230. The controller function 1210 and/or another remote machine (not shown) in communication with the controller function 1210 may implement a user interface providing one or more of the features discussed herein.

As shown in FIG. 12, the controller function 1210 may be deployed locally at the computer numerically controlled machine 1200. Alternatively and/or additionally, the controller function 1210 may be deployed at the computer 1220 and/or the cloud server 1230, both of which are communicatively coupled with the computer numerically controlled machine 1200 via network 1240. The network 1240 may be a wired network and/or a wireless network including, for example, a local area network (LAN), a virtual local area network (VLAN), a wide area network (WAN), a public land mobile network (PLMN), the Internet, and/or any other type of network configured now known or later developed that is sufficient for facilitating data communication and control signaling between and among the computer 1220, the CNC machine 1200, and the cloud server 1230. In operation, any of the rendering system features disclosed and described herein may be performed by any one or more of the CNC machine 1200, computer 1220, and/or cloud server 1230, individually or in combination. More broadly, any of the rendering system features disclosed and described herein may be performed by any one or more of a rendering machine, a controller device configured to communicate with and/or control the rendering machine, and/or cloud server configured to communication with and/or control the rendering machine, individually or in combination, as described further herein.

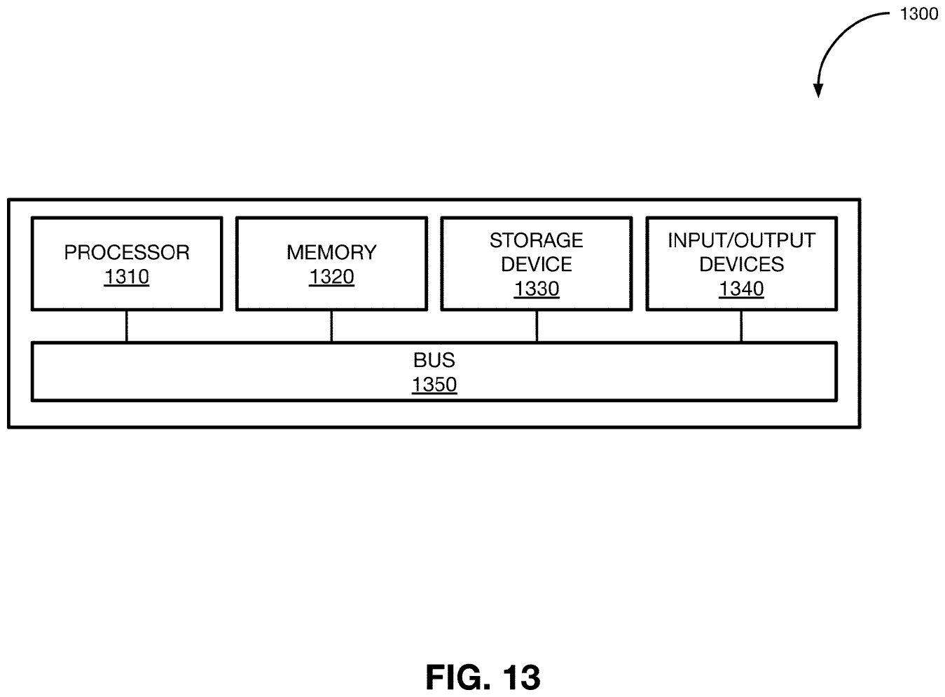

FIG. 13 depicts a block diagram illustrating a computing system 1300, consistent with some implementations of the current subject matter. Referring to FIG. 12, the example computing system 1300 may implement the controller function 1210. In operation, the CNC machine 1200 may comprise the components of example computing system 1300, the computer 1220 may comprise components of example computing system 1300, and the cloud server 1230 may comprise components of example computing system 1300.

As shown in FIG. 13, the example computing system 1300 includes one or more processor(s) 1310, one or more tangible, non-transitory computer-readable memory/media 1320 configured to hold program instructions for execution by the one or more processors 1310, a storage device 1330 configured to hold data files, and an input/output device(s) 1340, which could include sensors, displays, touch screens, keyboards, buttons, switches and/or any other type of input/output now known or later developed that is sufficient for receiving inputs for the example computing system 1300 and generating outputs from the example computing system 1300. The one or more processors 1310, the tangible, non-transitory computer-readable memory/media 1320, the storage device 1330, and the input/output devices 1340 are interconnected via a system bus 1350. The one or more processors 1310 are capable of processing and executing program instructions to implement at least some of the rendering system features/functions described here. In some implementations of the current subject matter, the one or more processors 1310 can be one or more single-threaded processors. Alternatively, the one or more processors 1310 can be one or more multi-threaded processors. The one or more processors 1310 are capable of processing instructions stored in the tangible, non-transitory computer-readable memory/media 1320 and/or data within the storage device 1330 to control and/or implement at least some of the operations of rendering system, including any one or more (or all) of the rendering machine, controller device, and/or cloud server.

The tangible, non-transitory computer-readable memory/media 1320 is a computer readable medium such as volatile or non-volatile memory that stores information within the computing system 1300. The memory 1320 can store data structures representing configuration object databases, for example. The storage device 1330 is capable of providing persistent storage for the computing system 1300. The storage device 1330 can be a solid state drive, a floppy disk device, a hard disk device, an optical disk device, or a tape device, or other suitable persistent storage means. The input/output device 1340 provides input/output operations for the computing system 1300. In some implementations of the current subject matter, the input/output device 1340 can provide input/output operations for a network device. For example, the input/output device 1340 can include Ethernet ports or other networking ports to communicate with one or more wired and/or wireless networks (e.g., a local area network (LAN), a wide area network (WAN), the Internet).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

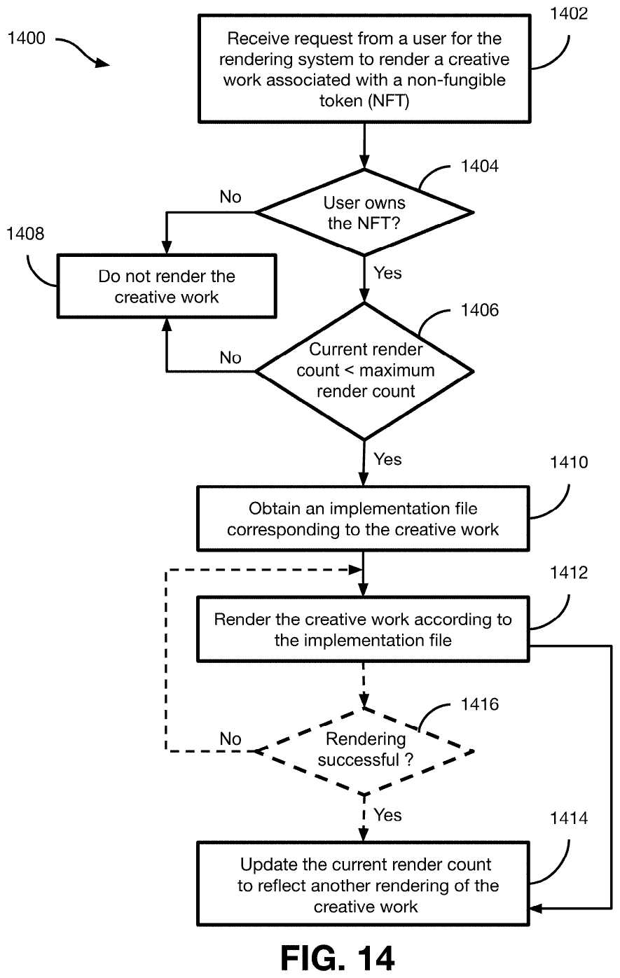

FIG. 14 depicts a method 1400 implemented by a rendering system according to some embodiments consistent with implementations of the current subject matter. In operation, the rendering system comprises any one or more of (i) a rendering machine, (ii) a computing device configured to control or communicate with the rendering machine, or (iii) a cloud-based server system configured to control or communicate with the rendering machine. For example, the rendering system may be similar to or the same as the rendering system shown and described with reference to FIG. 12.

In operation, any one or more of the steps of method 1400 performed by the rendering system can be performed directly or indirectly by any of the rendering machine, the computing device configured to control or communication with the rendering machine, or the cloud-based server system configured to control or communicate with the rendering machine, individually or in combination.

In some embodiments, the rendering machine component of the rendering system comprises any of the rendering machines disclosed or described herein, including but not limited to a printer, a three-dimensional printer, a computer numerical control (CNC) machine, a laser cutter, a video display screen, or any other type of machine or device now known or later developed that is suitable for rendering creative works in physical or ephemeral form. For example, the rendering machine component may include any of the CNC machines shown and described with reference to FIGS. 9-11.

Method 1400 begins at 1402, which includes the rendering system receiving a request from a user for the rendering system to render a creative work associated with an NFT. In some embodiments, the NFT corresponds to any of the NFT implementations disclosed or described herein (e.g., standard NFTs, vouched NFTs, chain-of-custody NFTs, transporter NFTs, owner-benefit NFTs) or any other type of NFT implementation that can be associated with a creative work and is suitable for use with the systems and methods described herein.

In some embodiments, the NFT is minted via a smart contract that runs on a blockchain such as Ethereum, Zilliqa, Flow, Tezos, Solana, Cardano, or any other blockchain suitable for implementing smart contracts or similar software schemes that are suitable for minting and/or performing transactions relating to NFTs. In practice, the process of minting the NFT via the smart contract includes associating the NFT with a creative work and/or an implementation file associated with the creative work as described herein.

In some embodiments, the NFT is associated with a creative work by virtue of information contained in the NFT metadata, which may include any one or more of: (i) a description of the creative work, (ii) a link (e.g., a Uniform Resource Identifier (URI) or Uniform Resource Locator (URL)) to an off-blockchain location where the creative work is stored, e.g., on the InterPlanetary File System (IPFS) or other off-blockchain location, (iii) a description of an implementation file for rendering the creative work, (iv) a link (e.g., a URI or URL) to an off-blockchain location where the implementation file for rendering the creative work is stored, (v) a blockchain address where the creative work or the implementation file for rendering the creative work is stored, and/or (iv) a link (e.g., a URI or URL) to another location that includes one or more other files associated with the NFT and/or the creative work.

In some embodiments, the association between the NFT and the creative work and/or corresponding implementation file is additionally or alternatively managed by a software agent (on the blockchain or off the blockchain) configured to maintain and manage an association between (i) the NFT (e.g., via the blockchain address of the smart contract that minted the NFT and the token identifier of the NFT) and (ii) the creative work and/or corresponding implementation file (e.g., via a creative work and/or implementation file itself or a URI or URL that points to the creative work and/or implementation file). In some embodiments, the above-described software agent may be a software component of the smart contract that minted the NFT. In other embodiments, the above-described software agent is separate from the smart contract that minted the NFT and may be implemented on the blockchain or off the blockchain.

In some embodiments, the above-described software agent configured to maintain and manage the association between the NFT and the corresponding creative work (and/or corresponding implementation file) is implemented by the rendering system (e.g., via the cloud-based rendering system server). In other embodiments, the above-described software agent configured to maintain and manage the association between the NFT and the corresponding creative work (and/or corresponding implementation file) is implemented by an entity different than the rendering system, but configured to communicate and exchange data with the rendering system.

In some embodiments, the NFT is also associated with one or more data files comprising publicly-viewable information to facilitate the purchase and sale of the NFT, and perhaps other functions in addition to purchasing and selling the NFT.

This publicly-viewable information may include any one or more of (i) one or more representations (e.g., visual, audio, audio-visual) of the creative work, e.g., a visual image of what the creative work will (or at least should) look like when rendered, (ii) an indication of the maximum render count corresponding to the preconfigured total number of authorized renderings of the creative work associated with the NFT, as described further herein, (iii) an indication of the current render count corresponding to how many times the creative work associated with the NFT has been previously rendered, as described further herein, and/or (v) a difference between the maximum render count and the current render count, which indicates how many authorized renderings of the creative work are still available to be performed. In some embodiments where the maximum render count corresponding to the preconfigured total number of authorized renderings of the creative work associated with the NFT is one (i.e., only a single rendering is authorized), the publicly-viewable information may include the current rendered status of the creative work, e.g., “rendered” or “not rendered.”

In some embodiments where the creative work is a visual, audio, audio/visual or similar form of ephemeral work intended for rendering in digital form, the one or more representations of the creative work may include a “low resolution” version of the creative work (or perhaps portions or subcomponents of the creative work) whereas the actual creative work would be ultimately rendered at a “high resolution” compared to the one or more “low resolution” representations.

In some embodiments, the smart contract that minted the NFT (and/or a different smart contract or software agent separate from the smart contract that minted the NFT) is additionally configured to implement various functions associated with one or more of (i) authenticating ownership of the NFT, (ii) transferring the NFT from one user (e.g., a seller or other transferor) to another user (e.g., a buyer or other transferee), and (iii) perhaps functions associated with coordinating the rendering of the creative work associated with the NFT.

In some embodiments, the request from the user corresponds to a request received via a user interface on a controller device, e.g., a computer, tablet, smartphone, or similar computing device. In some embodiments, the request from the user may correspond to a request issued by a software agent perhaps in response to the occurrence of some event. For example, a software agent configured to request and/or manage the rendering of a creative work may generate and send the request to the rendering system after receiving a request to render the creative work from the user. In another example, a software agent configured to request and/or manage the rendering of a creative work may generate and send the request to the rendering system after the occurrence of some other event, e.g., after a certain amount of time has elapsed since the creative work was most-recently rendered, after a certain amount of time has elapsed since the NFT associated with the creative work was minted, on the occurrence of a particular calendar date, after receiving an indication that a related NFT has been rendered, or some other occurrence that is sufficient for use as a triggering event that, when detected or determined by the software agent, causes the software agent to generate and send the request to the rendering system to cause the rendering system to render the creative work.

In some embodiments, the above-described software agent configured to request and/or manage the rendering of a creative work is implemented by the rendering system (e.g., via any of the rendering machine, the controller device, and/or cloud-based rendering system server). In other embodiments, configured to request and/or manage the rendering of a creative work is implemented by an entity different than the rendering system, but configured to communicate and exchange data with the rendering system and components thereof.

After receiving the request from the user for the rendering system to render the creative work associated with the NFT at block 1402, method 1400 advances to block 1404 which includes determining whether the user owns the NFT associated with the creative work.

In some embodiments, determining whether the user owns the NFT associated with the creative work includes querying or otherwise interacting with a smart contract and/or other software agent associated with the NFT to determine the owner of the NFT and/or to confirm whether the user is the actual owner of the NFT.

For example, in some embodiments, the NFT may be associated with a public key that is further associated with the NFT owner to facilitate determining whether the user who initiated the rendering request is the actual owner of the NFT.

In some scenarios, the NFT owner's public key may be added to the NFT metadata when the NFT owner purchases the NFT. Further, when the original NFT owner transfers the NFT to a new owner, the NFT metadata may be updated to delete the original NFT owner's public key and add the new NFT owner's public key. Because the NFT is stored on the blockchain, storing the NFT owner's public key directly in the NFT metadata makes it difficult (and practically impossible) for nefarious actors to alter the public key information stored in the NFT metadata because of the inherent characteristics of the blockchain.

In other scenarios, the NFT metadata includes a pointer to a file that indicates the current owner of the NFT, where the file that indicates the current owner is updated and maintained by a software agent associated with the NFT. In this second scenario, the metadata of the NFT need not be updated to reflect the current owner's public key. So, for implementations of this scenario where the software agent configured to update the public key of the owner in connection with NFT ownership transfers is implemented off of the blockchain, there is no requirement to perform a blockchain transaction to update the NFT metadata to reflect the public key of the new NFT owner. But while avoiding a blockchain transaction to update the NFT metadata may be somewhat easier (and at least for now, cheaper) than having to execute a blockchain transaction, this second scenario of updating the association between the NFT and the NFT owner's public key is less secure and more susceptible to manipulation by nefarious actors as compared to the first scenario where the new owner's public key is updated within the NFT metadata stored on the blockchain.

In either scenario, any person (or software agent) can access the NFT metadata and obtain the current NFT owner's public key (either directly from the metadata or from a file linked to within the NFT metadata) for use in determining whether a request to render a creative work was initiated by the actual owner of the NFT.

For example, in some embodiments, the request received from the user (or received from a software agent on behalf of the user) to render the creative work may include a digital signature created via the user's private key (i.e., the user's private key that corresponds to the user's public key associated with the NFT). After receiving the request comprising the digital signature from the user, a smart contract (or other software agent on or off the blockchain) can use the NFT owner's public key associated with the NFT to confirm that digital signature accompanying the rendering request corresponds to the public key associated with the NFT, and thus, confirm that the user whose digital signature accompanied the rendering request is the NFT owner. And after confirming that the user who initiated the rendering request is the actual NFT owner, the smart contract (or other software agent on or off the blockchain) sends (or causes to be sent) one or more messages to the rendering system (or perhaps individual component thereof) to confirm that the user who initiated the rendering request is the NFT owner. Other methods of confirming whether the user who initiated the rendering request is the actual owner of the NFT could be used as well.

If at block 1402, it is determined that the user does not own the NFT, then method 1400 advances to block 1408, which includes the rendering system declining to render the creative work. Some embodiments may additionally include generating a notification that the creative work cannot be rendered. In some embodiments, generating the notification includes causing a message or other indication to be displayed within a user interface, where the user interface may be a user interface on a rendering machine and/or a user interface on a controller device configured to control or communicate with the rendering machine.

But if at block 1402, it is determined that the user does own the NFT, then method 1400 advances to block 1406, which includes determining a current render count of the creative work associated with the NFT and/or determining whether the current render count indicates that the creative work associated with the NFT has been previously rendered fewer than a maximum render count corresponding to a preconfigured total number of authorized renderings of the creative work associated with the NFT.

As explained previously, in some embodiments, the NFT associated with the creative work may authorize a fixed number of renderings of the associated creative work, thereby limiting the total number of physical renderings of the creative work associated with the NFT. In operation, the current render count identifies how many times the creative work associated with the NFT has been rendered by a rendering system, and the maximum render count identifies how many total renderings of the creative work associated with the NFT were originally authorized by the creator of the NFT.

In some embodiments, the current render count and/or maximum render count may be stored or otherwise indicated in the metadata of the NFT. In such embodiments, determining the current render count and/or maximum render count involves examining the NFT metadata that corresponds to the current render count and/or maximum render count. In some embodiments, one or more smart contracts associated with the NFT are configured to update the current render count in the NFT metadata after each rendering of the creative work associated with the NFT.

In some embodiments, the current render count may be additionally or alternatively tracked by a file and/or software agent separate from the NFT. For example, the NFT metadata may contain a link to (i) a file that indicates the current render count and/or maximum render count and/or (ii) a smart contract or other software agent configured to track and maintain the current render count and/or maximum render count for the NFT. In such embodiments, determining the current render count and/or maximum render count includes querying the file and/or interacting with the smart contract or other software agent identified in the NFT metadata to obtain the current render count, the maximum render count, and/or how many authorized renderings are remaining. In such embodiments, the smart contract, software agent, or other suitable program is configured to update the current render count information for the NFT after each confirmed rendering of the creative work associated with the NFT. In some embodiments, updating the current render count information for the NFT by the smart contract, software agent, or other suitable program may include updating one or more portions of the NFT metadata that indicate the render count and/or the total number of authorized renderings remaining until the creative work associated with the NFT has been rendered the maximum number of authorized times (i.e., how many renderings remain until reaching the maximum render count).

If at block 1406, it is determined that the current count is equal to the maximum render count, then method 1400 advances to block 1408, which includes the rendering system declining to render the creative work. Instead of comparing the current render count to the maximum render count at block 1406, some embodiments may instead obtain the total number of renderings remaining from a smart contract, software agent, or other suitable program. Alternatively, if the function of determining whether additional renderings are available is implemented by a smart contract, software agent, or other suitable software program that is separate from the rendering system, block 1406 may instead include receiving an indication from the smart contract, software agent, or other suitable software program indicating or otherwise authorizing the rendering system to render the creative work.

As described above, in some embodiments, block 1408 may additionally include generating a notification that the creative work cannot be rendered. In some embodiments, generating the notification includes causing a message or other indication to be displayed within a user interface, where the user interface may be a user interface on a rendering machine and/or a user interface on a controller device configured to control or communicate with the rendering machine.

But if a block 1406, it is determined that the current render count is less than the maximum render count (i.e., the current render count indicates that the creative work has been previously rendered fewer than the maximum render count corresponding to the total number of authorized renderings of the creative work associated with the NFT), then method 1400 advances to block 1410, which includes causing the rendering system to obtain an implementation file corresponding to the creative work.

As described previously, in some embodiments, the creative work associated with the NFT has one or more corresponding implementation files, where the implementation file(s), when executed by a rendering machine (individually or in combination with other components of the rendering system), causes the rendering machine to render the creative work associated with the NFT.

For example, in embodiments where the rendering machine comprises a CNC machine, 3D printer, laser cutter, or similar manufacturing/fabrication device, the implementation file(s) includes instructions and/or other data that the rendering machine uses to render a physical/tangible version of the creative work. Similarly, in embodiments where the rendering machine comprises a video screen/player, music player, or similar device configured to render an ephemeral creative work, the implementation files(s) may include data or a stream of data that, when processed by the rendering machine, causes the rendering machine to display (or cause to be displayed) and/or play (or cause to be played) a digital version of the creative work.

In some embodiments, causing the rendering system to obtain the implementation file corresponding to the creative work at block 1410 includes causing the rendering system to obtain the implementation file from an escrow agent. In operation, the escrow agent stores the implementation file(s) and provides (or otherwise makes available) the implementation file(s) to the rendering system.

In some embodiments, the escrow agent is (or is a component of) a smart contract, software agent, or other suitable software program configured to provide (or otherwise make available) the implementation file(s) to the rendering system after receiving a request for the implementation file(s) from the rendering system (i.e., a request from any of the rendering machine, the controller associated with the rendering machine, and/or the cloud-based server system, individually or in combination).

In some embodiments, the escrow agent may correspond to a third party company that stores the implementation file(s) and provides the implementation file(s) upon request after confirming that the entity that has requested the implementation file(s) is the NFT owner (or is authorized by the NFT owner) to receive the implementation file(s). In some embodiments, the escrow agent may be implemented by the rendering system. For example, the escrow agent may be implemented by a software agent executed by the cloud-based rendering server. In operation, the rendering machine (or perhaps a controller device associated with the rendering machine) may request the implementation file(s) from the escrow agent implemented at the cloud-based rendering server. And in turn, the escrow agent at the cloud-based rendering server provides or otherwise makes available the implementation file(s) to the rendering machine for rendering the creative work.

In some embodiments, after the escrow agent receives a request for the implementation file(s), the escrow agent (i) uses the NFT owner's public key to encrypt the implementation file(s), and (ii) transmits (or otherwise provides or makes available) the encrypted implementation file(s) to the rendering system (e.g., to the rendering machine component of the rendering system). After receiving, downloading, or otherwise obtaining the encrypted implementation file(s) from the escrow agent, the rendering system can use the NFT owner's private key to decrypt the encrypted implementation file(s).

In some embodiments, the escrow agent stores the implementation file(s) in an encrypted form. For example, rather than using the NFT owner's public key to encrypt the implementation file(s) after receiving the request for the implementation file(s) in connection with a rendering request, the escrow agent may instead use the NFT owner's public key to encrypt the implementation file(s) in connection with the process of transferring the NFT from one owner to another owner (i.e., before receiving the rendering request from the new user).

In such embodiments, the process of transferring ownership of the NFT from a first owner to a second owner includes (i) the first owner using the private key corresponding to the public key currently associated with the NFT to decrypt the implementation file(s) (the success of which may be a condition precedent to the NFT transfer itself), and (ii) the escrow agent using the second owner's public key to re-encrypt the implementation file(s), thereby resulting in an encrypted version of the implementation file(s) that can only be decrypted by the corresponding private key held by the NFT owner. Recall that, in some embodiments, when the NFT is transferred from a first owner to a second owner, the data for the NFT is updated to reflect the public key for the second owner, i.e., either the NFT metadata is updated to reflect the new public key or file or other smart contract or software agent pointed to within the NFT metadata is updated to reflect the public key of the new user.

In such embodiments, updating and maintaining an association between the NFT and the NFT owner's public key, using the NFT owner's public key to encrypt (and then store) the implementation file(s), requiring the user (or a software agent acting on behalf of the NFT owner) to digitally sign the rendering request, and requiring the NFT owner (or a software agent on behalf of the NFT owner) to use the corresponding private key to decrypt the encrypted implementation file(s) before the rendering system can use implementation file(s) to render the creative work helps prevent a nefarious actor from obtaining and using the implementation file(s) to render unauthorized versions of the creative work.

Additionally or alternatively, the escrow agent may store an encrypted version of the implementation file(s) that has been encrypted independently from the NFT owner's public key as described above. In this scenario, when the escrow agent needs to provide the implementation file(s) to a rendering machine, the escrow agent (i) decrypts the implementation file(s), (ii) re-encrypts the implementation file(s) using the current NFT owner's public key, and (iii) transmits or otherwise makes available the re-encrypted version of the implementation file(s) to the rendering machine. The rendering machine (or a software agent running thereon) uses the current NFT owner's private key to decrypt the encrypted implementation file(s) obtained from the escrow agent for rendering the creative work.

Other methods of securely delivering or otherwise providing the implementation file(s) from the escrow agent to the rendering system could be used as well.

After obtaining the implementation file(s) at block 1410 (and perhaps decrypting the implementation file(s), depending on the embodiment), method 1400 advances to block 1412, which includes the rendering system rendering the creative work according to the implementation file(s).

In some embodiments, block 1412 may additionally include arranging for the delivery of the rendered creative work to the user who initiated the rendering request. For example, the user may be located somewhere physically remote from the rendering machine component of the rendering system that processed the rendering request and rendered the creative work. In operation, the user may interact with the rendering system via a controller device (e.g., the user's laptop computer, tablet computer, smartphone, or other computing device) that runs a software application. In operation, when the user requests that the rendering system render the creative work, the software application running on the user's controller device initiates the rendering request with the rendering system, i.e., the software application running on the user's controller device initiates the rendering request received by the rendering system at block 1402. Thus, after rendering the creative work at block 1412, method 1400 may additionally include arranging for shipping the rendered creative work to the user who initiated the rendering request received at block 1402. Arranging for shipping the rendered creative work may include generating a shipping request to a third party shipper, providing shipping information to the third party shipper, creating a shipping label, and/or other shipping related functions.

Next, method 1400 advances to block 1414, which includes updating the current render count to reflect that another rendering of the creative work has occurred, i.e., updating the render count to reflect the rendering that occurred in connection with block 1412. In some embodiments, updating the current render count includes at least one of (i) updating (or causing to be updated) one or more metadata fields in the NFT that indicate the current render count, and/or (ii) updating (or causing to be updated) information indicating the render count in one or more files associated with the NFT via one or more smart contracts, software agents, or other suitable software programs.

For example, some embodiments include the rendering system transmitting a rendering confirmation to (or otherwise causing a rendering confirmation to be provided to) a smart contract, software agent, or other suitable software program that is configured to update the render count for the NFT. In some embodiments, the smart contract, software agent, or other suitable software program may comprise or interface with one or more smart contracts implemented on a blockchain, which in some embodiment may include the smart contract that initially minted the NFT corresponding to the creative work. In operation, updating the render count for the NFT may be accomplished via any of the on-chain or off-chain procedures described previously with respect to updating the public key associated with the NFT owner, e.g., updating the NFT metadata to reflect the new render count, updating a file or program pointed to in the NFT metadata to reflect the new render count, and so on.

Some embodiments of method 1400 optionally include checking whether the rendering performed a block 1412 was successful before updating the current render count at block 1414.

For example, some embodiments additionally include method block 1416 which includes, after rendering the creative work according to the implementation file(s) at block 1412, determining whether the rendering system satisfactorily rendered the creative work. In some embodiments, determining whether the rendering system satisfactorily rendered the creative work is based on an indication from the user specifying whether the rendering of the creative work was satisfactory. For example, if a user inspects the rendering of the creative work and concludes that the rendering was unsatisfactory for some reason, the user may indicate the unsatisfactory rendering to the rendering system (e.g., via a user interface on the rendering machine and/or via a user interface on a controller device configured to control or communicate with the rendering machine).

In some embodiments that include rendering a tangible/physical rendering of the creative work, determining whether the rendering system satisfactorily rendered the creative work is additionally or alternatively based on a computer-analysis (e.g., an image analysis) of one or more images of the tangible/physical rendering of the creative work.

For example, a camera within the rendering machine may compare one or more images of the actual, tangible rendered creative work with one or more reference images to determine whether the tangible rendering was successful, e.g., individual cutouts appear to be the correct size and orientation, designs/script appear correctly proportional and properly aligned, and/or other quality checks.

In one example, cameras and/or sensors (e.g., cameras 1103a-c and/or sensor 1106, as shown in FIG. 11A) capture one or more images and/or measurements of the actual rendering and transmit the images and/or measurements to the cloud-based rendering server for comparison with one or more reference images and/or reference measurements. Alternatively, in some embodiments, the rendering machine may perform the comparisons locally rather than sending the images and/or measurements to the cloud-based rendering server for comparison.

This type of computer-implemented comparison of the image(s) and/or measurements of the actual tangible rendering of the creative with the reference image(s) and/or measurements of the creative work may be advantageous in scenarios where the creator of the creative work may desire some assurances that the actual tangible rendering of the creative work rendered in connection with the NFT meets certain minimum quality standards.

In some embodiments, determining whether the rendering was successful at method block 1416 includes a two-step process where, if the computer-implemented comparison of the the actual rendered creative work with the reference images/measurements suggests that the rendering was successful, then the rendering system awaits a final approval from the user.

In some embodiments, if it is determined at block 1416 that the rendering system did not satisfactorily render the creative work, then method 1400 additionally causes the rendering system to (i) destroy or damage at least a portion of the actual tangible rendering (the rendering that was deemed unsatisfactory) and (ii) then return to method block 1412, which includes rendering the creative work according to the implementation file(s) again. Destroying or damaging at least a portion of the actual tangible rendering in some embodiments includes the rendering system, for example, cutting the actual tangible rendering work into several pieces, destroying a design or script on the surface of the rendered creative work, defacing or otherwise damaging the surface of the actual tangible rendering, applying a “reject,” “void,” or similar indication on the surface of the rendering that identifies the actual tangible rendering as unsatisfactory in some respect.

Next, after rendering the creative work according to the implementation file(s) again at block 1412, method 1400 returns to block 1416, which includes determining whether this second actual tangible rendering was successful/satisfactory. And if at block 1416, it is determined that this second actual tangible rendering of the creative work was successful/satisfactory, then method 1400 advances to block 1414 which includes updating the current render count to reflect that another rendering of the creative work has occurred, i.e., the this second actual tangible rendering that occurred in connection with block 1412, as described above. Some embodiments may additionally include logging that an unsatisfactory rendering occurred. Logging that the unsatisfactory rendering occurred may also include storing at least some of the images and/or measurements of the unsatisfactory rendering that were captured by the one or more cameras and/or sensors of the rendering machine.

Some embodiments additionally include obtaining one or more images of the actual tangible rendering of the creative work (i.e., the successful rendering), and then associating those one or more images of the actual tangible rendering of the creative work with the NFT, or at least causing those one or more images to be associated with the NFT.

For example, consider a scenario where the maximum render count for the NFT is five, meaning that the NFT can be used to render only five instances of the creative work. After rendering the first instance of the creative work, the rendering system obtains images of the first instance and associates those images of the first rendering with the NFT. Some embodiments may additionally include generating a certificate of authenticity corresponding to this first rendering of the creative work. In operation, this first actual tangible rendering of the creative work can be assigned a serial number (e.g., Serial No. 1) and the images of this first actual tangible rendering of the creative work (i.e., Serial No. 1) can be associated with the certificate of authenticity and the serial number. In this way, anyone who later purchases this first actual tangible rendering of the creative work can compare the images of the first actual tangible rendering of the creative work to confirm that the “Serial No. 1” of the creative work they are purchasing is the same (or at least appears to be the same) as what is shown in the images that captured at the time of that Serial No. 1 was rendered by the rendering system.

In operation, this same process can be executed for each actual tangible rendering of the creative work such that, after all five authorized renderings have been completed, each authorized rendering with its assigned serial number has its own corresponding certificate of authenticity as well as a set of images associated therewith that can be used by later purchasers to verify the authenticity of the actual tangible renderings of the creative work.

In some embodiments, method 1400 additionally includes deleting (or causing to be deleted) the implementation file(s) associated with the NFT after rendering the last authorized rendering of the creative work associated with the NFT. For example, in a scenario where the NFT authorizes only 20 renderings of the creative work associated therewith, after completing the 20th authorized rendering of the creative work associated with the NFT, method 1400 additionally includes deleting (or causing to be deleted) the implementation file(s) associated with the NFT so that the implementation file(s) can no longer be used to render additional versions/instances of the creative work associated with the NFT.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. Tangible, non-transitory computer-readable media comprising program instructions stored therein, wherein the program instructions, when executed by one or more processors, cause a rendering system to perform functions comprising:
after receiving a request from a user for the rendering system to render a creative work associated with a non-fungible token, determining (i) whether the user owns the non-fungible token and (ii) a current render count corresponding to how many times the creative work associated with the non-fungible token has been previously rendered; and
when the user owns the non-fungible token and the current render count indicates that the creative work has been previously rendered fewer than a maximum render count corresponding to a preconfigured total number of authorized renderings of the creative work associated with the non-fungible token, causing the rendering system to (i) obtain an implementation file corresponding to the creative work, (ii) render the creative work according to the implementation file, and (iii) update the current render count to reflect another rendering of the creative work.

2. The tangible, non-transitory computer-readable media of claim 1, wherein the program instructions comprise further program instructions that, when executed by the one or more processors, cause the rendering system to perform further functions comprising:
declining to render the creative work associated with the non-fungible token when either (i) the user does not own the non-fungible token or (ii) the user owns the non-fungible token but the current render count indicates that the creative work has been previously rendered the maximum render count corresponding to the preconfigured total number of authorized renderings.

3. The tangible, non-transitory computer-readable media of claim 1, wherein causing the rendering system to obtain the implementation file corresponding to the creative work comprises:
obtaining the implementation file from an escrow agent, wherein the escrow agent is implemented via one or more of (i) one or more smart contracts associated with the non-fungible token or (ii) one or more software agents.

4. The tangible, non-transitory computer-readable media of claim 1, wherein the non-fungible token is associated with one or more data files comprising publicly-viewable information comprising one or more of (i) one or more visual representations of the creative work, (ii) an indication of the maximum render count corresponding to the preconfigured total number of authorized renderings of the creative work associated with the non-fungible token, (iii) an indication of the current render count corresponding to how many times the creative work associated with the non-fungible token has been previously rendered, (iv) a difference between the maximum render count and the current render count, or (v) a public key associated with a current owner of the non-fungible token.

5. The tangible, non-transitory computer-readable media of claim 1, wherein causing the rendering system to update the current render count to reflect another rendering of the creative work comprises:
obtaining data sufficient to uniquely identify the rendered creative work; and
causing the data sufficient to uniquely identify the rendered creative work to be associated with the non-fungible token.

6. The tangible, non-transitory computer-readable media of claim 1, wherein the functions further comprise, after rendering the creative work according to the implementation file, additionally:
causing generation of a certificate of authenticity associated with the rendered creative work.

7. The tangible, non-transitory computer-readable media of claim 1, wherein the functions further comprise, after rendering the creative work according to the implementation file, additionally:
determining whether the rendering system satisfactorily rendered the creative work according to the implementation file based on at least one of (i) an indication from the user specifying whether the rendering of the creative work was satisfactory or (ii) a computer-analysis of one or more images of the rendered creative work;
when the rendering system did not satisfactorily render the creative work according to the implementation file, causing the rendering system to (i) damage at least a portion of the rendered creative work and (ii) render the creative work according to the implementation file again; and
wherein causing the rendering system to update the current render count to reflect another rendering of the creative work comprises causing the rendering system to update the current render count to reflect another rendering of the creative work when the rendering system satisfactorily rendered the creative work according to the implementation file.

8. The tangible, non-transitory computer-readable media of claim 1, wherein the rendering system comprises one or more of (i) a rendering machine, (ii) a computing device configured to control or communicate with the rendering machine, or (iii) a cloud-based server system configured to control or communicate with the rendering machine.

9. The tangible, non-transitory computer-readable media of claim 8, wherein the rendering machine comprises one of (i) a printer, (ii) a three-dimensional printer, (iii) a computer numerical control (CNC) machine, (iv) a laser cutter, or (v) a video display screen.

10. A rendering system comprising:
one or more processors; and
one or more tangible, non-transitory computer-readable media comprising program instructions stored therein, wherein the program instructions, when executed by the one or more processors, cause the rendering system to perform functions comprising:
after receiving a request from a user for the rendering system to render a creative work associated with a non-fungible token, determining (i) whether the user owns the non-fungible token and (ii) a current render count corresponding to how many times the creative work associated with the non-fungible token has been previously rendered; and
when the user owns the non-fungible token and the current render count indicates that the creative work has been previously rendered fewer than a maximum render count corresponding to a preconfigured total number of authorized renderings of the creative work associated with the non-fungible token, causing the rendering system to (i) obtain an implementation file corresponding to the creative work, (ii) render the creative work according to the implementation file, and (iii) update the current render count to reflect another rendering of the creative work.

11. The rendering system of claim 10, wherein the program instructions further comprise program instructions that, when executed by the one or more processors, cause the rendering system to perform further functions comprising:
declining to render the creative work associated with the non-fungible token when either (i) the user does not own the non-fungible token or (ii) the user owns the non-fungible token but the current render count indicates that the creative work has been previously rendered the maximum render count corresponding to the preconfigured total number of authorized renderings.

12. The rendering system of claim 10, wherein the function of causing the rendering system to obtain the implementation file corresponding to the creative work comprises:
obtaining the implementation file from an escrow agent, wherein the escrow agent is implemented via one or more of (i) one or more smart contracts associated with the non-fungible token or (ii) one or more software agents.

13. The rendering system of claim 10, wherein the non-fungible token is associated with one or more data files comprising publicly-viewable information comprising one or more of (i) one or more visual representations of the creative work, (ii) an indication of the maximum render count corresponding to the preconfigured total number of authorized renderings of the creative work associated with the non-fungible token, (iii) an indication of the current render count corresponding to how many times the creative work associated with the non-fungible token has been previously rendered, (iv) a difference between the maximum render count and the current render count, or (v) a public key associated with a current owner of the non-fungible token.

14. The rendering system of claim 10, wherein the function of causing the rendering system to update the current render count to reflect another rendering of the creative work comprises:
obtaining data sufficient to uniquely identify the rendered creative work; and
causing the data sufficient to uniquely identify the rendered creative work to be associated with the non-fungible token.

15. The rendering system of claim 10, wherein the functions further comprise, after rendering the creative work according to the implementation file, additionally:
causing generation of a certificate of authenticity associated with the rendered creative work.

16. The rendering system of claim 10, wherein the functions further comprise, after rendering the creative work according to the implementation file, additionally:
determining whether the rendering system satisfactorily rendered the creative work according to the implementation file based on at least one of (i) an indication from the user specifying whether the rendering of the creative work was satisfactory or (ii) a computer-analysis of one or more images of the rendered creative work;
when the rendering system did not satisfactorily render the creative work according to the implementation file, causing the rendering system to (i) damage at least a portion of the rendered creative work and (ii) render the creative work according to the implementation file again; and
wherein causing the rendering system to update the current render count to reflect another rendering of the creative work comprises causing the rendering system to update the current render count to reflect another rendering of the creative work when the rendering system satisfactorily rendered the creative work according to the implementation file.

17. The rendering system of claim 10, wherein the rendering system comprises one or more of (i) a rendering machine, (ii) a computing device configured to control or communicate with the rendering machine, or (iii) a cloud-based server system configured to control or communicate with the rendering machine.

18. The rendering system of claim 17, wherein the rendering machine comprises one of (i) a printer, (ii) a three-dimensional printer, (iii) a computer numerical control (CNC) machine, (iv) a laser cutter, or (v) a video display screen.

19. A method performing by a rendering system, the method comprising:
after receiving a request from a user for the rendering system to render a creative work associated with a non-fungible token, determining (i) whether the user owns the non-fungible token and (ii) a current render count corresponding to how many times the creative work associated with the non-fungible token has been previously rendered; and
when the user owns the non-fungible token and the current render count indicates that the creative work has been previously rendered fewer than a maximum render count corresponding to a preconfigured total number of authorized renderings of the creative work associated with the non-fungible token, causing the rendering system to (i) obtain an implementation file corresponding to the creative work, (ii) render the creative work according to the implementation file, and (iii) update the current render count to reflect another rendering of the creative work.

20. The method of claim 19, wherein the rendering system comprises one or more of (i) a rendering machine, (ii) a computing device configured to control or communicate with the rendering machine, or (iii) a cloud-based server system configured to control or communicate with the rendering machine; and
wherein rendering machine comprises one of (i) a printer, (ii) a three-dimensional printer, (iii) a computer numerical control (CNC) machine, (iv) a laser cutter, or (v) a video display screen.
